(19) United States
(12) Patent Application Publication
(10) Pub. No.: US 2023/0349266 A1
(43) Pub. Date: Nov. 2, 2023

(54) Integrated Wellsite System and Method for Greenhouse Gas Capture and Sequestration

(71) Applicant: Patterson-UTI Drilling Company LLC, Houston, TX (US)

(72) Inventors: William Andrew HENDRICKS, JR., Houston, TX (US); Abelardo A. GALLO, Houston, TX (US); Roger Bartlett WILLIS, Meadville, PA (US)

(73) Assignee: Patterson-UTI Drilling Company LLC, Houston, TX (US)

(21) Appl. No.: 18/158,118

(22) Filed: Jan. 23, 2023

Related U.S. Application Data
(60) Provisional application No. 63/335,798, filed on Apr. 28, 2022.

(51) Int. Cl. E21B 41/00; E21B 43/26; E21B 43/16

(52) U.S. Cl. CPC E21B 41/0064; E21B 43/2605; E21B 43/164

(57) ABSTRACT

The disclosure provides a modular, scalable, and transportable system for capture and sequestration of wellsite greenhouse gas emissions, such as carbon dioxide, by integrating exhaust gas collection equipment, greenhouse gas capture equipment, greenhouse gas compression equipment, and a method enabling sequestration of the gas into well construction equipment and processes. The captured gas can be compressed or otherwise formed into a denser gas fluid, and injected into a geological formation, such as a shale formation. Enhancements to fracking processes can be provided by intercalating or otherwise mixing the gas fluid with fracking fluid. The gas fluid can be geologically sequestered by its interaction with and adsorption into the formation. The sequestered gas fluid can enhance hydrocarbon recovery by reduction of oil interfacial tension in the formation and desorption of methane from the formation. The gas fluid can also be absorbed into the formation or sequestered in other wells or storage facilities.

### CROSS REFERENCE TO RELATED APPLICATIONS

This application claims the benefit of U.S. Provisional Application Ser. No. 63/335,798, entitled “Integrated Wellsite System and Method for Greenhouse Gas Capture and Sequestration”, filed Apr. 28, 2022, which is incorporated herein by reference.

### STATEMENT REGARDING FEDERALLY SPONSORED RESEARCH OR DEVELOPMENT

Not applicable.

### REFERENCE TO APPENDIX

Not applicable.

### BACKGROUND OF THE INVENTION

### Field of the Invention

The disclosure generally relates to efficient capture and sequestration of gaseous products at a wellsite. More specifically, the disclosure relates to capture and sequestration at a wellsite of potentially harmful greenhouse gases generated at a wellsite.

### Description of the Related Art

A growing concern in environmental protection is the increase of greenhouse gases. Greenhouse gases absorb and radiate heat gradually over time and help moderate global temperatures. However, an overabundance of greenhouse gases is believed to cause climate change and harm to the environment. Greenhouse gases include carbon dioxide, methane, nitrous oxide, and others. Carbon dioxide absorbs less heat than methane and nitrous oxide, but is far more abundant and stays in the atmosphere much longer. Some studies show that increases in atmospheric carbon dioxide contribute to about two-thirds of an apparent total energy imbalance that is believed to be causing Earth's temperature to rise.

Significant efforts are being made to reduce production of greenhouse gases, particularly carbon dioxide due to its volume generated from combustion engines using fossil fuels that exhaust the carbon dioxide. However, current technology and infrastructure heavily relies on fossil fuels and the associated engines for a functional society. Examples of such use of large fossil fuel engines are wellsite electric power generation equipment, such as in oilfield drilling, completion, and production platforms operations, as well as powering fracturing equipment (also known as frack pumps) in unconventional fracturing operations where tens of thousands of hydraulic horsepower (HHP) are needed for a single wellsite for the various operations.

FIG. 1 is a schematic diagram of a system with fossil fuel equipment for a typical wellsite during an unconventional formations fracturing operation with typical emissions of greenhouse gases. The wellsite 6 with fracking capabilities includes a fracking system 1 having one or more fracking units 11. The fracking units receive low-pressure fracking fluid made of sand-like particles mixed with water and other components and pump the fracking fluid to a high pressure such as 10,000 psi. The high-pressure fracking fluid is pumped into a well 5 at the wellsite to flow into a hydrocarbon-bearing formation 7 below the Earth's surface. The high-pressure liquid fractures the formation structure and the sand-like particles help maintain the formation fractures open after the high-pressure liquid flow ceases. The fracturing provides more surface area exposure for a higher recovery of hydrocarbons trapped in the formation.

A fracking unit 11 typically includes a power supply such as an internal combustion engine (ICE), gas turbine (GT), or another source of power, with an ICE 13 being the most common and will be used throughout this discussion as an example. The fossil fuel is typically diesel, gasoline, propane, or natural gas. The fracking system 1 couples an ICE 13 with a high-pressure fracking pump 14 having a low-pressure portion 15 to receive fracking fluid 4′ from a fracking fluid inlet low-pressure manifold 29. The pump 14 increases the pressure of the incoming fracking fluid in the high-pressure portion 16, and pumps the fluid into an output manifold 17 to join output from other fracking units to flow into the well 5.

The ICEs produce combustion exhaust gas in the process with greenhouse gas components. A typical composition of exhaust gas from a diesel engine is: carbon dioxide of about 12%; methane, nitrous oxide, and others of about 1%; nitrogen of about 67%; oxygen of about 9%; and water of about 11%. Greenhouse gases include carbon dioxide, methane, nitrous oxide, and others. Carbon dioxide absorbs less heat than methane and nitrous oxide, but is far more abundant and stays in the atmosphere much longer. Studies estimate that exhaust gases 8A, 8B, 8C, with a 3%-15% carbon dioxide concentration from a fleet of ICEs 13 used during a fracturing operation can produce up to 250 tons of carbon dioxide per day for emission into the atmosphere. Until alternative forms of power generation equipment become commercially available, the fossil fuel power generation equipment will be needed and, without a solution, will continue to produce carbon dioxide that is released into the atmosphere.

FIG. 2 is a schematic diagram of a system with fossil fuel equipment for a typical wellsite within the same field as the wellsite illustrated in the FIG. 1 fracturing wellsite, during a drilling operation with typical emissions of greenhouse gases. A drilling rig power system 2 includes drilling rig equipment 3 powered by electrical generation equipment, designated herein as one or more power generator units 12. The power generator unit 12 includes power equipment such as an ICE 13 coupled with a generator 9. The ICE likewise produces exhaust gas with greenhouse gas components. A typical drilling operation with a drilling rig uses less power per day than the fracking system described above, typically up to 25 tons of carbon dioxide per day for emission into the atmosphere.

Therefore, there is a need for a system and method for capture and sequestration of greenhouse gases, such as carbon dioxide, at or near the wellsite to reduce the amount of greenhouse gases being released to the atmosphere.

### BRIEF SUMMARY OF THE INVENTION

The disclosure provides a system to capture greenhouse gas, such as carbon dioxide, from exhausts of any greenhouse gas emission sources on site, liquefy it, and inject it into a subsurface formation via a fracturing process or transport to another location for other uses or permanent geological storage. The system can be an in-situ closed loop system in that the capture of the wellsite's greenhouse gas emissions and injection into the formation occurs at the same wellsite or nearby wellsites in the same field to avoid long-term surface storage and transportations. The system can be modular, scalable, and transportable. The system can be installed as a centralized bulk unit in land drilling rigs and fracking fleets for collection, capture, liquification, storage, and sequestration of the whole wellsite's greenhouse gas emissions, or in another configuration it can be installed as decentralized smaller individual units coupled with each individual greenhouse gas generating equipment at the wellsite. The system can integrate exhaust gas collection equipment, greenhouse gas capture equipment, and greenhouse gas liquification equipment into well construction equipment and processes to enable injection and geological sequestration of the greenhouse gas.

The disclosure provides an integrated system for capture and sequestration of greenhouse gas, the system configured to interface with wellsite exhaust gas generation equipment that generates exhaust gas having at least one greenhouse gas and fracking equipment that injects a flow stream of high-pressure fracking fluid into a downhole geological formation, comprising: exhaust gas collection equipment configured to collect the exhaust gas from the gas generation equipment; greenhouse gas capture equipment configured to receive a flow of the exhaust gas from the exhaust gas collection equipment and separate the greenhouse gas to be captured from the exhaust gas; greenhouse gas liquification equipment configured to receive a flow of the greenhouse gas from the greenhouse gas capture equipment and reduce the greenhouse gas to a greenhouse gas fluid; greenhouse gas fluid storage equipment configured to receive a flow of the greenhouse gas fluid from the greenhouse gas liquification equipment and at least temporarily store the greenhouse gas fluid; and greenhouse gas fluid injection equipment configured to receive a flow of the greenhouse gas fluid from the greenhouse gas fluid storage equipment and inject the greenhouse gas fluid into the geological formation for sequestration. The system can be an in-situ system for capture and sequestration.

The disclosure also provides a system for capturing greenhouse gas at a wellsite, the system configured to interface with wellsite exhaust gas generation equipment that generates exhaust gas having at least one greenhouse gas, comprising: greenhouse gas capture equipment configured to receive a flow of the exhaust gas and separate the greenhouse gas from the exhaust gas; greenhouse gas liquification equipment configured to receive a flow of the greenhouse gas from the greenhouse gas capture equipment and reduce the greenhouse gas to a greenhouse gas fluid, and greenhouse gas fluid storage equipment configured to receive a flow of the greenhouse gas fluid from the greenhouse gas liquification equipment and at least temporarily store the greenhouse gas fluid for at least one of injection into a geological formation at the wellsite and transportation to another location.

The disclosure further provides a system for sequestering greenhouse gas into a wellsite geological formation, the system having fracking equipment that injects high-pressure fracking fluid into the geological formation, comprising: greenhouse gas fluid injection equipment configured to receive a greenhouse gas fluid captured from exhaust gas and to inject the greenhouse gas fluid into the geological formation for sequestration.

The disclosure provides a system of storing a quantity of a gas fluid with storage containers having a total capacity less than the quantity of the gas fluid, comprising: a first storage container configured to load a portion of the quantity of gas fluid and thereafter unload the portion for processing or transportation; a second storage container configured to load a next portion of the quantity of gas fluid when the first storage container is configured to unload the portion and thereafter unload the next portion for processing or transportation; the first storage container configured to load a further next portion of the quantity of gas fluid when the second storage container is configured to unload the next portion and thereafter unload at least the further next portion for processing or transportation; and wherein the first storage container is configured to continue to load and unload when the second storage container is configured to unload and load respectively until the quantity of the gas fluid has been loaded and unloaded.

The disclosure also provides an integrated method for capture and sequestration of greenhouse gas from wellsite exhaust gas generation equipment that generates exhaust gas having at least one greenhouse gas and fracking equipment that injects a flow stream of high-pressure fracking fluid into a downhole geological formation, comprising: collecting with exhaust gas collection equipment the exhaust gas from the gas generation equipment; receiving with greenhouse gas capture equipment a flow of the exhaust gas from the exhaust gas collection equipment and separating the greenhouse gas to be captured from the exhaust gas; receiving with greenhouse gas liquification equipment a flow of the greenhouse gas from the greenhouse gas capture equipment and reducing the greenhouse gas to a greenhouse gas fluid; receiving with greenhouse gas fluid storage equipment a flow of the greenhouse gas fluid from the greenhouse gas liquification equipment and at least temporarily storing the greenhouse gas fluid; and receiving with greenhouse gas fluid injection equipment a flow of the greenhouse gas fluid from the greenhouse gas fluid storage equipment and injecting the greenhouse gas fluid into the geological formation for sequestration.

The disclosure further provides a method of storing a quantity of a gas fluid with storage containers having a total capacity less than the quantity of the gas fluid, comprising: loading a portion of the quantity of gas fluid in a first storage container and thereafter unloading the portion for processing or transportation; load a next portion of the quantity of gas fluid in a second storage container when unloading the portion in the first storage container and thereafter unloading the next portion in the second storage container for processing or transportation; load a further next portion of the quantity of gas fluid in the first storage container when unloading the next portion in the second storage container and thereafter unloading at least the further next portion in the first storage container for processing or transportation; and repeating loading and unloading the first storage container when unloading and loading the second storage container respectively until the quantity of the gas fluid has been loaded and unloaded.

### BRIEF DESCRIPTION OF THE SEVERAL VIEWS OF THE DRAWINGS

FIG. 1 is a schematic diagram of a typical fracking system with fossil fuel equipment for a wellsite during a fracturing operation with typical emissions of greenhouse gases.

FIG. 2 is a schematic diagram of a typical drilling rig system with fossil fuel equipment for a wellsite during a drilling operation with typical emissions of greenhouse gases.

FIG. 3A is a schematic diagram showing an example of an embodiment of an integrated wellsite fracking system with centralized exhaust gas collection from various ICEs with greenhouse gas capture, liquification, storage, and injection of greenhouse gas fluid for downhole sequestration during fracturing operations.

FIG. 3A1 is a schematic diagram of a waste heat power generation system that optionally can be coupled to systems described herein to provide power to the equipment used during exhaust gas collection, greenhouse capture, storage, and liquification.

FIG. 3A2 is a schematic diagram of an example of a timed sequence for greenhouse gas liquification and storage containers loading and unloading during fracking operations to manage large greenhouse volumes, such as shown in FIG. 3A and FIG. 4B.

FIG. 3B is a schematic diagram showing an example of another embodiment of the integrated wellsite fracking system and method for standalone greenhouse gas fluid injection for subsequent downhole injection and sequestration during fracturing operations using greenhouse gas captured and liquified from another location.

FIG. 4A is a schematic diagram showing an example of an embodiment of an integrated wellsite drilling rig system and method for centralized exhaust gas collection, greenhouse gas capture, and liquification during drilling operations to be transported for injection and downhole sequestration at another location.

FIG. 4B is a schematic diagram showing an example of another embodiment of the integrated wellsite fracking system and method for standalone exhaust gas collection, greenhouse gas capture, and liquification during fracturing operations to be transported for injection and downhole sequestration at another location.

FIG. 5 is a schematic diagram showing an example of an embodiment of greenhouse gas capture equipment.

FIG. 6 is a schematic diagram showing an embodiment of an individual fracking unit coupled with a greenhouse gas capture unit.

FIG. 7 is a schematic diagram showing a wellsite fracturing system having a plurality of individual greenhouse gas capture fracking units, the system further having greenhouse gas fluid storage equipment and greenhouse gas fluid injection equipment for injecting greenhouse gas fluid into a well formation.

FIG. 7A is a schematic diagram of an example of a timed sequence for greenhouse gas liquification and storage containers loading and unloading during fracking operations to manage large greenhouse volumes, such as shown in FIG. 7.

FIG. 8 is a schematic diagram showing an embodiment of an individual power generator unit coupled with a greenhouse gas capture unit used to power at least partially a drilling rig.

FIG. 9 is a schematic diagram showing a drilling rig system having a plurality of individual greenhouse gas capture power generator units to collect and store for transportation to another location.

FIG. 10 is a schematic diagram showing an example of an embodiment with a first wellsite as a greenhouse gas capture wellsite while drilling and a second wellsite as a greenhouse gas sequestration wellsite while fracturing for a combined capture and sequestration system having a carbon neutral operation.

### DETAILED DESCRIPTION

The Figures described above and the written description of specific structures and functions below are not presented to limit the scope of what Applicant has invented or the scope of the appended claims. Rather, the Figures and written description are provided to teach any person skilled in the art to make and use the inventions for which patent protection is sought. Those skilled in the art will appreciate that not all features of a commercial embodiment of the inventions are described or shown for the sake of clarity and understanding. Persons of skill in this art will also appreciate that the development of an actual commercial embodiment incorporating aspects of the present disclosure will require numerous implementation-specific decisions to achieve the developer's ultimate goal for the commercial embodiment. Such implementation-specific decisions may include, and likely are not limited to, compliance with system-related, business-related, government-related, and other constraints, which may vary by specific implementation or location, or with time. While a developer's efforts might be complex and time-consuming in an absolute sense, such efforts would be, nevertheless, a routine undertaking for those of ordinary skill in this art having benefit of this disclosure. It must be understood that the inventions disclosed and taught herein are susceptible to numerous and various modifications and alternative forms. The use of a singular term, such as, but not limited to, “a,” is not intended as limiting of the number of items. Further, the various methods and embodiments of the system can be included in combination with each other to produce variations of the disclosed methods and embodiments. Discussion of singular elements can include plural elements and vice-versa. References to at least one item may include one or more items. Also, various aspects of the embodiments could be used in conjunction with each other to accomplish the understood goals of the disclosure. Unless the context requires otherwise, the term “comprise” or variations such as “comprises” or “comprising,” should be understood to imply the inclusion of at least the stated element or step or group of elements or steps or equivalents thereof, and not the exclusion of a greater numerical quantity or any other element or step or group of elements or steps or equivalents thereof. The term “coupled,” “coupling,” “coupler,” and like terms are used broadly herein and may include any method or device for securing, binding, bonding, fastening, attaching, joining, inserting therein, forming thereon or therein, communicating, or otherwise associating, for example, mechanically, magnetically, electrically, chemically, operably, directly or indirectly with intermediate elements, one or more pieces of members together and may further include without limitation integrally forming one functional member with another in a unity fashion. The coupling may occur in any direction, including rotationally. The device or system may be used in a number of directions and orientations. The order of steps can occur in a variety of sequences unless otherwise specifically limited. The various steps described herein can be combined with other steps, interlineated with the stated steps, and/or split into multiple steps. Some elements are nominated by a device name for simplicity and would be understood to include a system or a section, such as a controller would encompass a processor and a system of related components that are known to those with ordinary skill in the art and may not be specifically described. Various examples are provided in the description and figures that perform various functions and are non-limiting in shape, size, description, but serve as illustrative structures that can be varied as would be known to one with ordinary skill in the art given the teachings contained herein. Any expressions of percentage ranges and other ranges herein are inclusive, unless stated otherwise, and increments of the range can increase and decrease by integer numbers or fractions, so that for example a range of 0 to 10 includes 0 and 10 and any and all integers therebetween (e.g. 1, 2, 3 . . . ) and any and all fractions between each integer (e.g. 0.1, 0.2, 0.3, . . . and 0.01, 0.02, 0.03, . . . , and so forth). The term “in-situ” as used herein is intended to include movement, including transportation within an area encompassed by a field of production or exploration. The term “wellsite” as used herein is intended to mean an area encompassing at least one well within a field of production or exploration and surrounding area used for operations conducted on the at least one well. The term “sequestration:” as used herein is intended to mean a storage of gas in any phase in a subsurface formation, such as by adsorption or absorption; in a surface opening, such as a well, reservoir, or other cavity; in a designated long term storage facility; in storage containers for use in enhanced oil recovery facilities; in storage containers for industrial or commercial use in processes; or in other storage containers in which use reduce an amount of gas entering the Earth's atmosphere.

The disclosure provides a system for capture and sequestration of wellsite greenhouse gas emissions, such as carbon dioxide, by integrating exhaust gas collection equipment, greenhouse gas capture equipment, greenhouse gas liquification equipment, greenhouse gas fluid storage equipment, and greenhouse gas fluid injection equipment into well construction equipment and a method of injection of greenhouse gas fluid during fracturing operations, enabling subsequent geological sequestration of the greenhouse gas. The system can be modular, scalable, and transportable. The system can be installed as a centralized bulk unit in land drilling rigs and fracking fleets for collection, capture, liquification, storage, and sequestration of the whole wellsite's greenhouse gas emissions, or in another configuration it can be installed as decentralized smaller individual units coupled with each individual greenhouse gas generating equipment at the wellsite. The captured greenhouse gas can be compressed or otherwise liquified into a gas fluid that is denser than a gas phase. In some embodiments, the gas fluid can be temporarily stored and distributed in a substantially continuous stream for process stability. The gas fluid can become a supercritical gas fluid at higher compression pressures within the fracturing equipment in preparation for injection into a formation, such as a Shale formation. Enhancements to unconventional formation fracking processes can be provided by intercalating or otherwise mixing such gas fluid with fracking fluid. The gas fluid can be geologically sequestered by its interaction with and adsorption into the formation or absorption into the formation. Further, the sequestered gas fluid can enhance hydrocarbon recovery by reduction of oil interfacial tension in the formation and by desorption of methane from the formation.

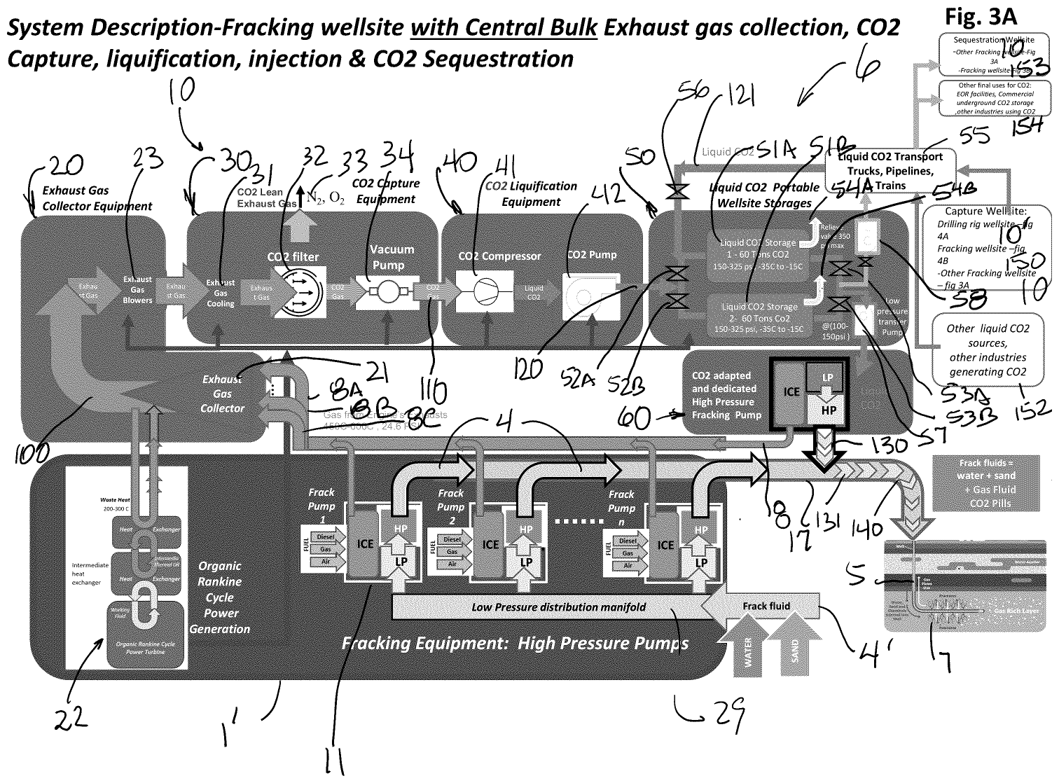

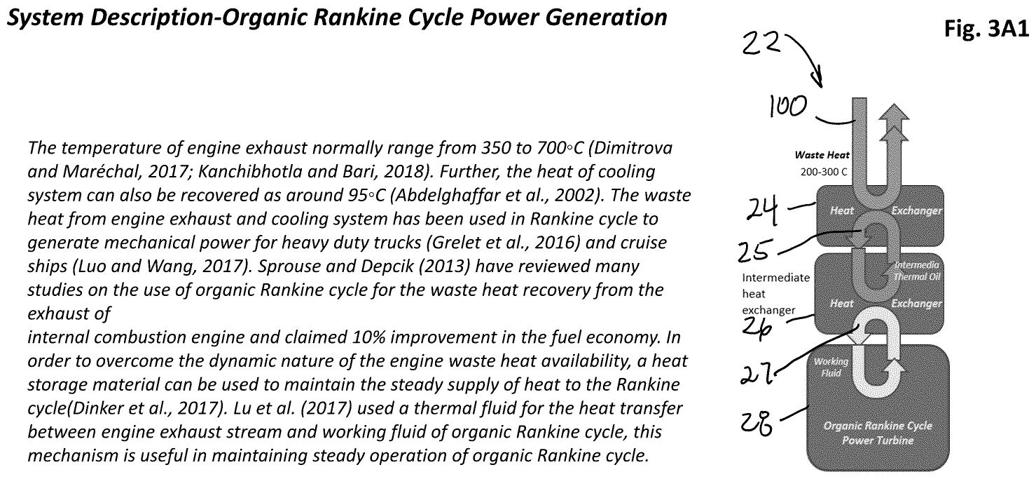

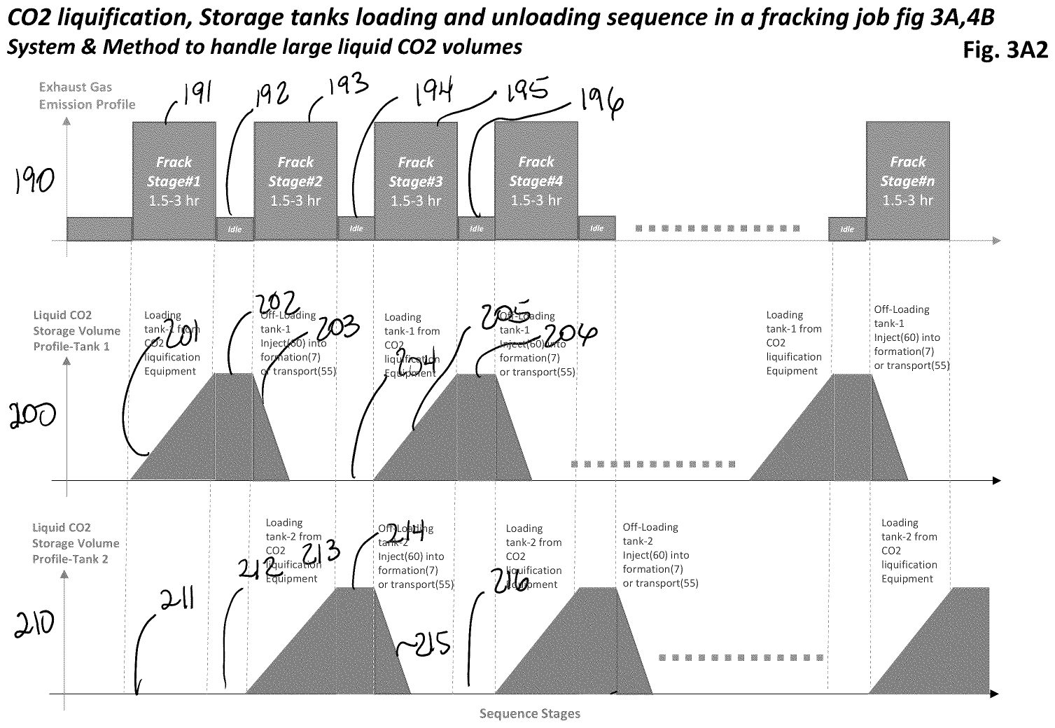

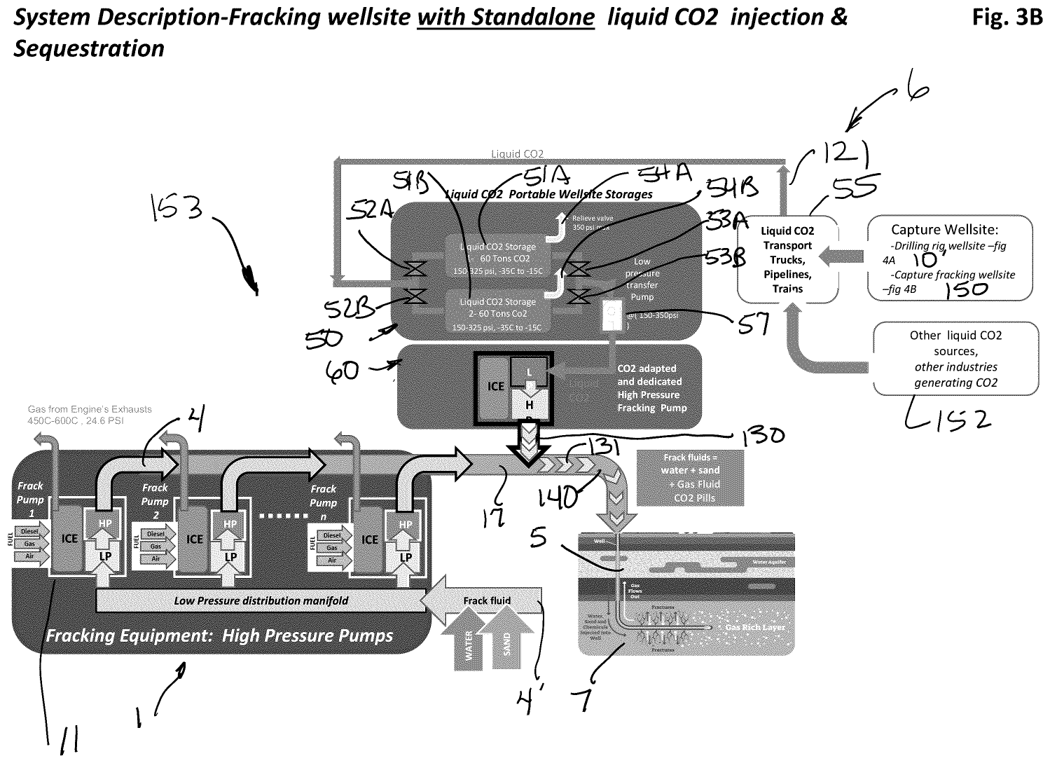

FIG. 3A is a schematic diagram showing an example of an embodiment of an integrated wellsite fracking system with centralized exhaust gas collection from various ICEs, with greenhouse gas capture, liquification, storage, and injection of greenhouse gas fluid for downhole sequestration during fracturing operations. Capture and sequestration of carbon dioxide will be used as an example herein due to its prominence in environmental concerns, with the understanding that the principles can apply to other gases that may be desired to capture, including other greenhouse gases. Thus, this embodiment can be considered a capture and sequestration fracking system 10. (It is understood FIG. 3A can be considered as both a capture fracking system and a fracking sequestration wellsite in reference to other embodiments described herein, due to the capability of both functions.)

The exhaust gas collection equipment can aggregate exhaust gases, such as exhaust gases 8A, 8B, and 8C (generally, “8” herein) from a fleet of power generation equipment at the wellsite to form a combined exhaust gas 100 for processing. Optionally, the exhaust gas collection equipment can include ancillary equipment, including without limitation prefilters for particulates, liquids, and other contaminates for a cleaner gas effluent from the exhaust gas collection equipment; pressure compensators; controls; and other appropriate features with the collection of gases, while avoiding performance-affecting back pressure into ICEs. In some embodiments, the exhaust gas collection equipment can collect gas from other sources besides the exhaust gas at the wellsite.

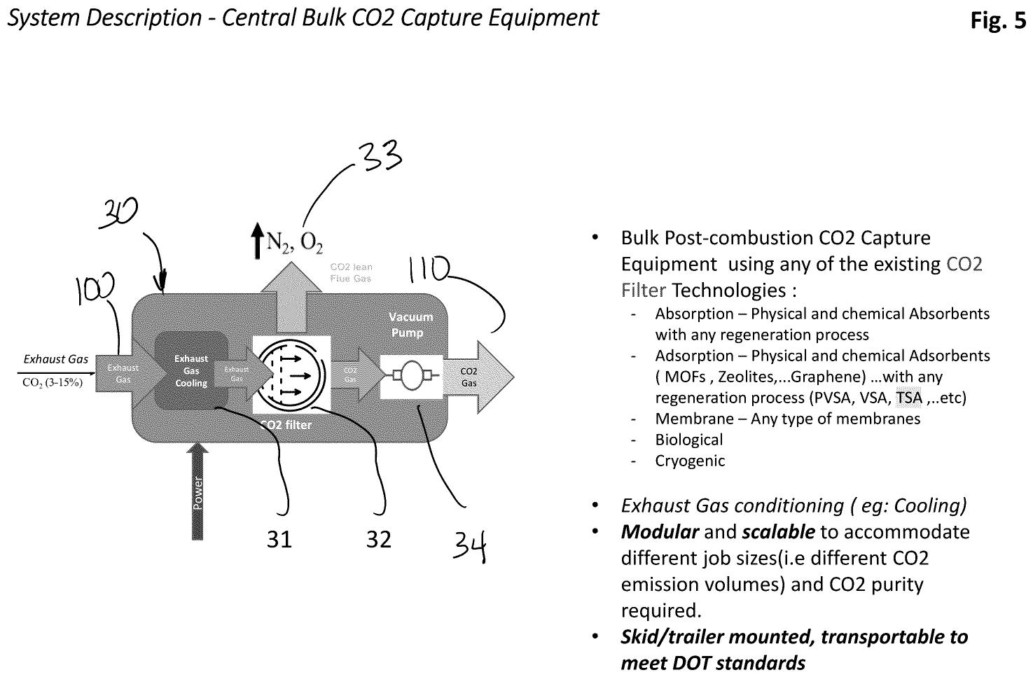

Greenhouse gas capture equipment 30 can be coupled to, and is generally downstream of, the exhaust gas collection equipment 20 for capturing the desired greenhouse gas, with carbon dioxide being the example of a desired greenhouse gas. Carbon dioxide can be captured in the greenhouse gas capture equipment and separated from other gases in the exhaust gas 100 stream received from the exhaust gas collection equipment. An example of greenhouse gas capture equipment is shown and described in FIG. 5 below. Undesirable gas 33 for sequestration purposes, such as nitrogen and oxygen, which remain after the desirable gas is separated can be released to the atmosphere. Alternatively, other greenhouse gas capture equipment (not shown) can be coupled to the embodiment of the greenhouse gas capture equipment or the upstream exhaust gas collection equipment to capture other gases, instead of releasing such gases to the atmosphere. The goal of the greenhouse gas capture equipment is a purified greenhouse gas 110 of a desired composition for a next step in the system process. Without limitation, an example of a desirably purified greenhouse gas 110 would be at least 90% pure, more desirable is at least 95% pure, further desirable is at least 99% pure, and still further desirable is at least 99.9% pure, and any value between such values, although other values may be acceptable for given commercial and technical reasons.

Greenhouse gas liquification equipment 40 that compresses the purified greenhouse gas 110 to a smaller volume can be coupled to, and is generally downstream of, the greenhouse gas capture equipment 30. In at least one embodiment, the greenhouse gas liquification equipment can compress the purified greenhouse gas 110 to a compressed gas 120 having a pressure that advantageously reduces the gaseous volume and may compress sufficiently to a supercritical or liquid fluid (herein, collectively referred to as a “gas fluid” unless stated otherwise). Other methods of creating a denser fluid from the greenhouse gas are also available, such a temperature-induced densification.

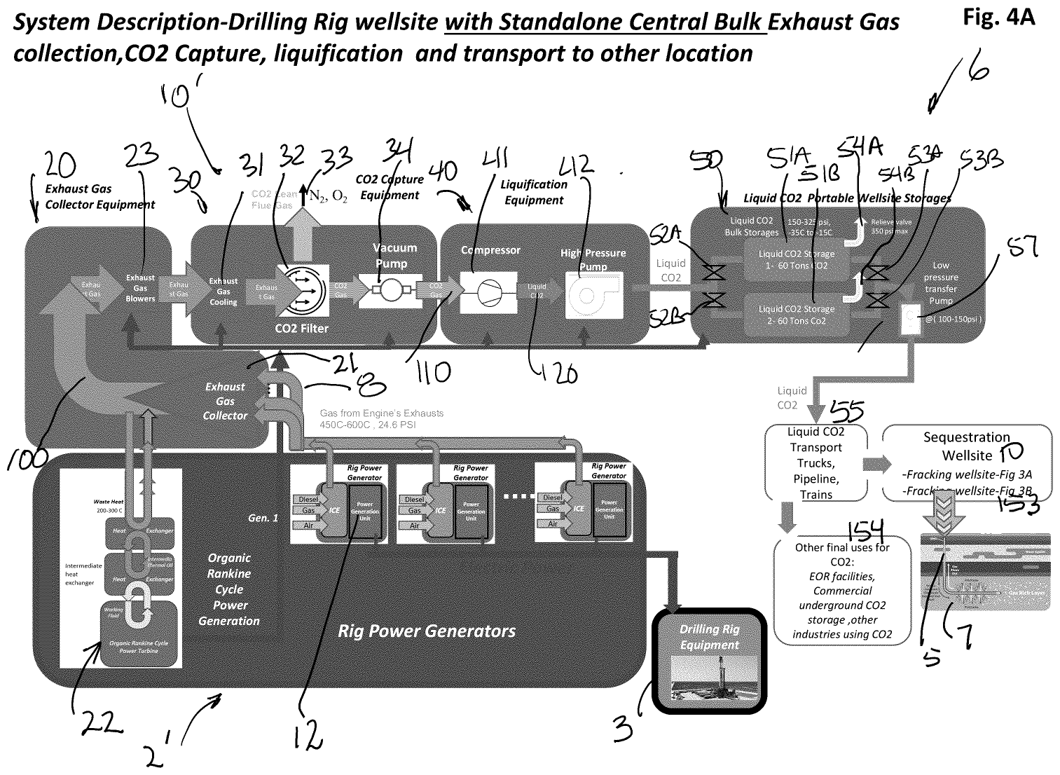

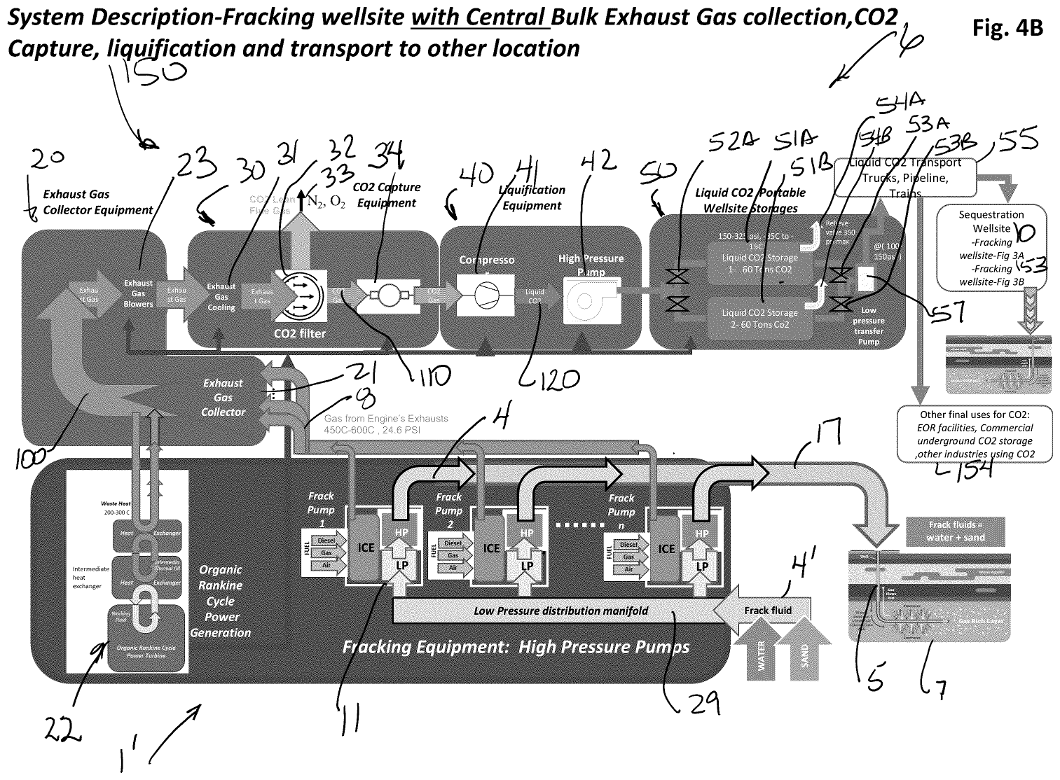

Greenhouse gas fluid storage equipment 50, such as wellsite portable gas fluid storage containers, can be coupled to, and is generally downstream of, the greenhouse gas liquification equipment 40. The greenhouse gas fluid storage equipment can be portable to accompany movement of the fracking equipment (or drilling rig equipment) or can be portable to other wellsites and locations for sequestration operations or other use. Further, additional quantities of a gas can be transported from other wellsites and systems that can be nearby, advantageously as a gas fluid 121 for efficiency of storage volume. For example, other wellsites can be a drilling wellsite with a capture drilling rig system 10′ such as shown in FIG. 4A, a fracking wellsite with a capture system 150 such as shown in FIG. 4B, or other wellsites from which a greenhouse gas is captured, as well as other gas fluid sources 152, including wellsites outside the field, industries that produce a gas, and other sources of gas. The flow of the additional gas, advantageously in the form of a gas fluid 121, can be controlled through a valve 56 and mixed into the gas fluid 120 of the greenhouse gas fluid storage equipment 50. For example, such transportation of the additional gas fluid 121 can occur with containers, transport vehicles, rail cars and trains, pipelines, and other transportation equipment (herein referred to as a “transporter” 55) and related methods.

The greenhouse gas fluid injection equipment 60 can be coupled to, and is generally downstream of, the greenhouse gas fluid storage equipment 50. In at least one embodiment, the greenhouse gas fluid injection equipment 60 can be one or more modified fracking units 11 with the associated pumps being configured to pump at low temperatures for the incoming cooled gas fluid 120. The greenhouse gas fluid injection equipment can create a gas fluid 130 with sufficiently high pressure for the gas to become supercritical or a liquid and sufficiently high pressure to merge such gas fluid into the fracking fluid 4 stream in the output manifold 17 to form a gas fracking fluid 140. The gas fracking fluid 140 can be injected into the well 5 to enter the formation 7 for fracking of the formation and subsequent sequestration of the gas fluid.

In at least one embodiment, a method used for sequestering the greenhouse gas can include injecting discrete portions of the gas fluid 130 (herein, “pills” 131) by intercalating discrete portions of the gas fluid into the fracking fluid 4 stream. Generally, a pill volume is relatively small compared to a fracking fluid volume. In at least one embodiment, the pills can interact with the formation 7, such as a shale formation, and become relatively permanently sequestered in the formation via an adsorption process. Alternatively, the gas fluid 130 can be injected as a continuous stream for example at an early stage, such as the beginning, of the fracturing stage, followed by the fracturing fluid downhole into the formation. Gas shale formations appear to be particularly receptive for such processes. Gas shale formations have a high adsorption preference for at least carbon dioxide and possibly other gases. For example, Busch, A; et al., in “Carbon dioxide storage potential of shales.” Int. J. Greenhouse Gas Control 2008, 2 (3), 297-308, shows that a carbon dioxide storage capacity of gas shale formations is in the range of about 220-390 moles per cubic meter (“mol/m³”) compared to sandstone of 8-10 mol/m³ or coal of 3-4 mol/m³. Further, the sequestered gas fluid, such as carbon dioxide, can cause desorption of methane (CH₄) from the gas shale formations and reduction of oil interfacial tension, leading to enhanced hydrocarbon recovery from oil shale formations.

Further, the captured greenhouse gas in FIG. 3A can be pumped by a low-pressure transfer pump 58 to a transporter 55 for outbound delivery of the greenhouse gas, preferably as a gas liquid 120. For example, the gas fluid can transported to another capture and sequestration fracking system 10 such as shown in FIG. 3A, a fracking sequestration wellsite 153 such as shown in FIG. 3B, and other gas use locations 154.

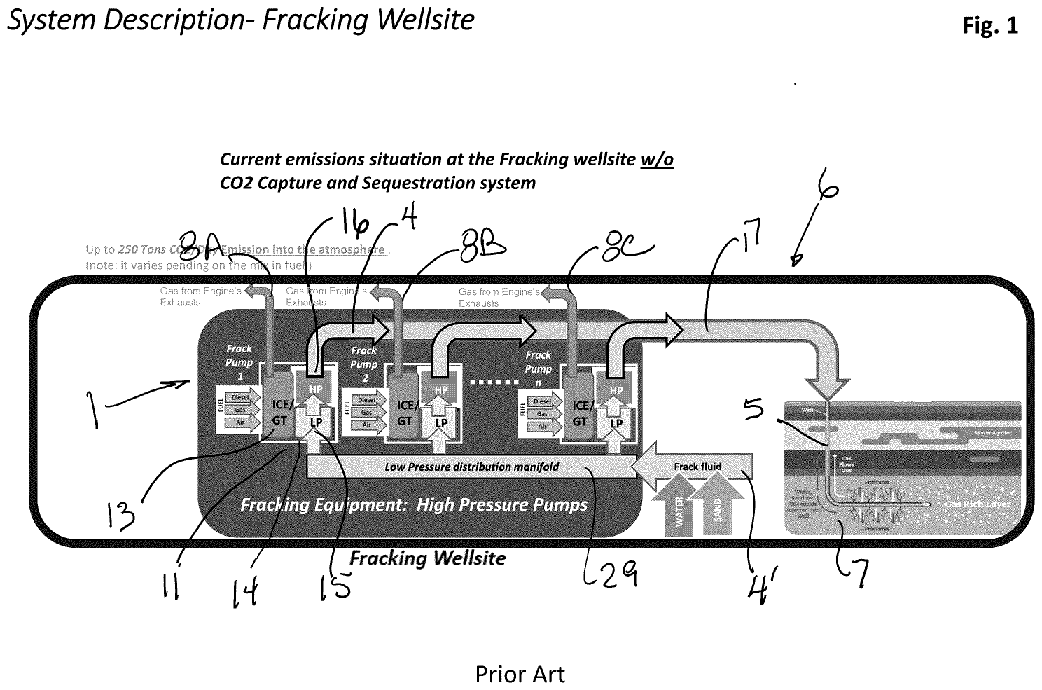

Having described general principles of at least one of the systems and method, a more particular description of various embodiments follows. In the embodiment of FIG. 3A, the fracking system 1′ can include multiple fracking units 11, such as described in FIG. 1. The exhaust gases 8 from the ICEs of the multiple fracking units 11 can be combined in an exhaust gas collector 21 of the exhaust gas collection equipment 20 for a combined exhaust gas 100 flow. Additionally, the fracking system 1′ can include a waste heat power generation system 22, explained in more detail below. In general, the waste heat power generation system 22 can divert at least a portion of the exhaust gas 100 into one or more heat exchangers, so that a power turbine produces power for at least some of the equipment in the system of the invention, making the greenhouse gas capture system at least partially energy self-sufficient and more efficient.

The exhaust gas collection equipment 20 can include an exhaust gas blower 23. The exhaust gas blower provides additional energy for the exhaust gas 100 to pass through stages of the system, while avoiding performance-affecting back pressure into ICEs. The exhaust gas can flow to the greenhouse gas capture equipment 30.

The greenhouse gas capture equipment 30 can include a gas cooler 31 to cool the exhaust gas downstream of the exhaust gas blower, which can be fluidicly coupled together through a conduit. The greenhouse gas capture equipment can also include an greenhouse gas filter 32 coupled downstream of the exhaust gas cooler for filtering out one or more of the components in the exhaust gas, such as carbon dioxide, and releasing the undesirable gas 33 into the atmosphere (which may not be greenhouse gases), while retaining the purified greenhouse gas 110. Optionally, the purified greenhouse gas 110 can flow to other multiple stages of filtering equipment for like processing out additional undesirable gases.

A vacuum pump 34 can be coupled downstream of the filter 32 to provide additional energy for the gas to pass through the filter. Other devices can be used instead of the vacuum pump depending of the releasing and regeneration methods suitable for the greenhouse filter. The purified greenhouse gas 110 can flow through a conduit to the greenhouse gas liquification equipment 40.

The greenhouse gas liquification equipment 40 can include a relatively low-pressure gas compressor 41 to form a compressed gas fluid 120 for an initial volume reduction and energy increase, followed by a higher pressure pump 42 to increase pressure of the gas fluid. The gas fluid can be pumped to a greenhouse gas fluid storage equipment 50, which can be at the wellsite in this embodiment.

The greenhouse gas fluid storage equipment 50 preferably stores the gas fluid at a relatively low-pressure of a few hundred pounds per square inch (“psi”), such as 150 psi to 325 psi as a nonlimiting pressure range, to minimize the storage container manufacturing expense. To maintain the gas fluid in a liquid state at that pressure range, the gas fluid needs to be chilled, such as to a temperature range of −35 C to −15 C. To adapt to the intermittent nature of the fracturing stages during operations that creates an intermittent flow of greenhouse gas fluid 120 and to establish a relatively continuous flow to downstream high-pressure greenhouse gas fluid injection equipment 60, multiple storage containers 51A and 51B, such as large storage tanks, can be used so that one or more containers may be feeding the gas fluid 120 to the greenhouse gas fluid injection equipment, while one or more other containers are being filled with the gas fluid, as further described in FIG. 3A2. Inlet valves 52A and 52B can direct which container receives incoming gas fluid. The typical high volume of exhaust gas would direct those to ordinary skill in the art to size the containers and provide an appropriate number of containers for the desirable continuous flow during the fracturing operations. Outlet valves 53A and 53B can direct which container feeds the stored gas fluid into downstream equipment. Relief valves 54A and 54B can protect the containers from over-pressurization, such as might be caused through a loss of the cooling capacity on the storage containers. Conduits connected with tees, ells, and other fittings can fluidicly link the storage containers, valving, sensors, controllers and other equipment. Further, the gas fluid 121 can be transported to the wellsite via a transporter 55, such as a pipeline, truck, or railroad. In addition to the collection and capture system for the greenhouse gas described in this embodiment, various sources that can supply greenhouse gas, advantageously in the form of a gas fluid 121, include: wellsites having a capture drilling rig systems 10′, such as shown in FIG. 4A; a capture fracking system 150, such as shown in FIG. 4B; another capture and sequestration fracking system 10, and other gas fluid sources 152. A low-pressure CO2 transfer pump 57 in the general range of 100-150 psi can transfer the gas fluid from the storage gas storage containers 51 to high-pressure greenhouse gas fluid injection equipment 60. Optionally, a low pressure transfer pump 58 can pump at the least some of the gas fluid 120 from the storage containers 51 to be transported via the transporter 55 to other locations. For example, other locations could include other wellsites and systems, such as another capture and sequestration fracking system 10, fracking sequestration system 153 without capture facilities, such as shown in FIG. 3B for sequestration of the gas fluid in a well for a formation 7; and other gas use locations 154, such as enhanced oil recovery facilities, commercial underground greenhouse gas storage, and other facilities using greenhouse gas.

The greenhouse gas fluid injection equipment 60 can be a modified fracking unit 11 with the associated pump being configured to pump at low temperatures for the incoming cooled gas fluid 120. The greenhouse gas fluid injection equipment can create a gas fluid 130 with sufficiently high pressure for the gas to become supercritical or a liquid at sufficiently high surface temperatures and with sufficiently high pressure to inject in the form of intercalating pills 131 or in a continuous stream for the particular volume into the fracking fluid 4 stream in the output manifold 17 to form a gas fracking fluid 140. The gas fracking fluid 140 can continue downhole into the well 5 and then into the formation 7 for fracturing and sequestration of the gas fluid 140.

FIG. 3A1 is a schematic diagram of a waste heat power generation system that optionally can be coupled to systems described herein to provide power to the equipment used during exhaust gas collection, greenhouse capture, storage, and liquification. The waste heat power generation system 22 can at least partially power the exhaust gas collection equipment, greenhouse gas capture equipment, and greenhouse liquification equipment in the embodiments described herein. In at least one embodiment, an Organic Rankine Cycle can be implemented. The system 22 can be incorporated into the overall systems at a point in which the exhaust gas 100 has high energy, generally close to the exhaust gas collection equipment 20. The temperature of exhaust gas at the ICE is typically from 350 to 700° C. Further, the heat of an ICE cooling system can also be recovered at around 95° C. Waste heat from the ICE exhaust gas and cooling system can be used to generate mechanical power. The system 22 can receive hot exhaust gas 100 from an outlet of a main exhaust gas flow, pass through a first heat exchanger 24 to transfer some of the exhaust gas heat energy, and then return to the main flow of the combined exhaust gas 100 at a lower temperature. In the first heat exchanger 24, an intermediate fluid known as a thermal oil, can flow in a closed intermediate heat transfer loop that is coupled to both the first heat exchanger 24 and the second heat exchanger 26. The intermediate fluid circulates in its intermediate heat transfer loop 25 back to the first heat exchanger 24 to be reheated by more exhaust gas 101 passing through the first heat exchanger. The intermediate fluid is fluidicly separate from the hot exhaust gas 100 flow, but is heated by the exhaust gas in the first heat exchanger. The intermediate fluid can then heat a working fluid in a similar manner. The working fluid flows in a closed working fluid loop 27 that is coupled to both the second heat exchanger 26 and a power generation unit 28. The working fluid is fluidicly separate from the intermediate fluid, but is heated by the intermediate fluid in the second heat exchanger 26. The intermittent nature of the well construction processes of drilling and/or fracturing creates an intermittent flow of exhaust gases and therefore a fluctuation in the waste heat. To provide a more stable flow of energy in the waste heat power generation system 22, the intermediate fluid in the loop 25 acts as a heat energy buffer between the exhaust gas 100 and the working fluid in the loop 27 to moderate fluctuations in the flow of the exhaust gas and the transferable heat. The working fluid can flow through the loop 27 and power generation unit 28 to generate power such as by mechanically turning a power turbine or other power generation equipment 28. The power generation equipment 28 can generate electricity for the equipment in the overall system, such as in the exhaust gas collection equipment 20, greenhouse gas capture equipment 30, greenhouse gas liquification equipment 40, and greenhouse gas fluid storage equipment 50, with little to no additional energy from an external source for such equipment.

FIG. 3A2 is a schematic diagram of an example of a timed sequence for greenhouse gas liquification and storage containers loading and unloading during fracking operations to manage large greenhouse volumes, such as shown in FIG. 3A and FIG. 4A. As described above, a large quantity of exhaust gas is generated due to the enormous power required during a fracking operation. A container sufficiently large to contain a day's amount of gas fluid 120, described above, to be generated from the exhaust gas would be practically unfeasible. The invention contemplates at least two containers 51A and 51B, such as storage tanks, with at least two staged sequences of loading and unloading throughout the fracking operation so that one container with the gas fluid can be unloaded during the fracturing while another container is being loaded with gas fluid, and then vice versa. The sequence timing allows much smaller containers to be used. In FIG. 3A2, three graphs are shown in relation to each other for the sequence. Fracking graph 190 represents a sequence of operation of the ICE(s) during a fracking operation. Container 1 graph 200 represents a sequence of operation of at one least one storage container for the greenhouse gas fluid, such as storage container 51A. Container 2 graph 210 represents a sequence of operation of at one least one other storage container for the greenhouse gas fluid, such as storage container 51B.

During an initial start of operations, the ICEs may be idling or off, and the containers unfilled with gas fluid. Upon starting fracking operations with an ICE operating, the ICE generates exhaust gas in fracking sequence 191 that is processed into the gas fluid, as described above. Concurrently during sequence 191, the gas fluid flows into Container 1 in sequence 201 to progressively load Container 1. Also, concurrently during sequence 191, Container 2 can remain unloaded in sequence 211 while Container 1 is being loaded. When the particular stage of fracking operation ceases and the ICE is idle or off in fracking sequence 192, little to no exhaust gas is generated and so the volume of gas fluid in Container 1 can remain substantially stable in sequence 202, while Container 2 remains unloaded in sequence 212.

When the next stage of fracking operation begins in fracking sequence 193, the initial status of the Container 1 has become loaded, while Container 2 has remained unloaded. In sequence 203, the gas fluid in Container 1 can be injected into the fracking fluid to form the gas fracking fluid 140 to flow into the subsurface formation, as described above. In at least one embodiment, the gas fluid can flow at an initial portion of the fracking sequence 193 followed by a substantial amount of the fracking fluid to frack the formation and push the gas fluid into the formation for sequestration. In another embodiment as described above, the gas fluid can be intercalated into the fracking fluid to achieve the sequestration. While the gas fluid from the Container 1 is being unloaded in sequence 203, Container 2 can be loaded in sequence 213 with the gas fluid generated during the fracking sequence 193, in a similar manner as Container 1 was loaded in sequence 201. After the end of the fracking sequence 193, the gas fluid from Container 1 has been substantially unloaded in sequence 203, and Container 2 has been substantially loaded with gas fluid in sequence 213. When the particular stage of fracking operation in fracking sequence 193 ceases and the ICE is idle or off in fracking sequence 194, little to no exhaust gas is generated and Container 1 can remain in an unloaded condition in sequence 204, while Container 2 can remain loaded with the gas fluid in sequence 214.

When the next stage of fracking operation begins in fracking sequence 195, Container 1 can be loaded in sequence 205 with gas fluid generated during the fracking sequence 195, as Container 2 was loaded in sequence 213 (and Container 1 was loaded in sequence 201). Concurrently in sequence 215, the gas fluid in Container 2 can be injected into the fracking fluid to form the gas fracking fluid 140 to flow into the subsurface formation in at least one of the embodiments described above. After the end of the fracking sequence 195, the gas fluid from Container 2 has been substantially unloaded in sequence 215 and Container 1 has been substantially loaded with gas fluid in sequence 205. When the particular stage of fracking operation in fracking sequence 195 ceases and the ICE is idle or off in fracking sequence 196, little to no exhaust gas is generated and Container 1 can remain loaded with the gas fluid in sequence 206, while Container 2 can remain unloaded in sequence 214. Such reciprocal processing between the containers can continue until fracking operations are finished.

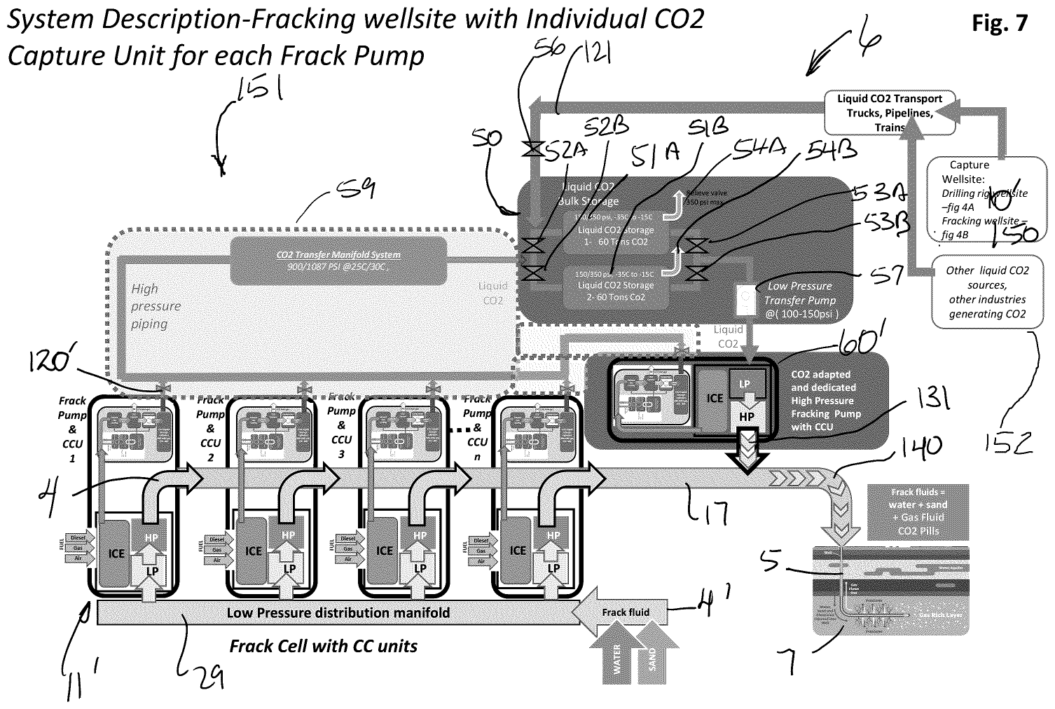

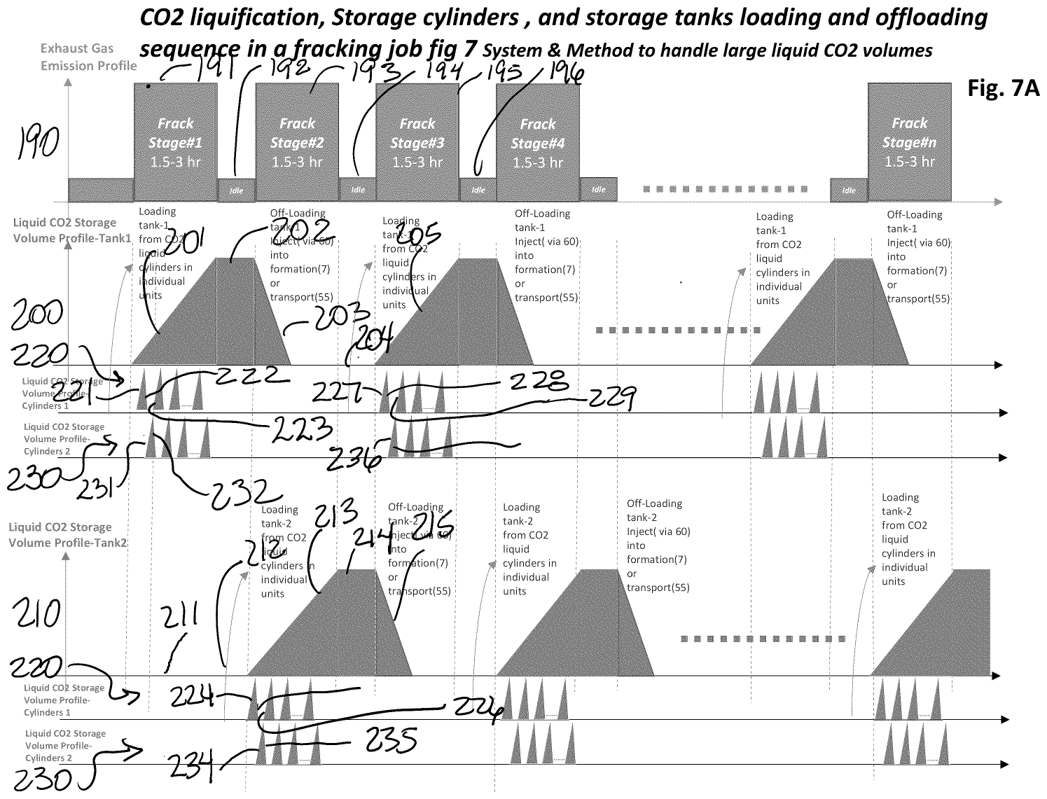

The above description of sequence has been in the context of fracking operations and sequestration at the same wellsite, such as illustrated in FIGS. 3A and 7. The sequence applies to those embodiments that capture gas and transport to other locations for sequestration in formations, or other uses, such as illustrated in FIGS. 3B, 4A, 4B, 9, and 10. In such embodiments, the unloading of each container in the described sequences is contemplated to occur by the gas fluid being transported by the transporter 55 as an example.

FIG. 3B is a schematic diagram showing an example of another embodiment of the integrated wellsite fracking system and method for standalone greenhouse gas fluid injection for subsequent downhole injection and sequestration during fracturing operations using greenhouse gas captured and liquified from another location. This embodiment covers scenarios in which a fracking sequestration system 153 may not collect exhaust gas from its ICEs nor capture its greenhouse gases for various reasons, but rather the system can receive greenhouse gas fluid from other wellsites and other sources for injection and sequestration during its fracking process (herein, a “fracking sequestration wellsite”). The fracking sequestration wellsite can use a fracking system 1 with one or more fracking units 11, such as described in FIG. 1, to provide the high-pressure fracking fluid into an output manifold 17 for injecting into a well 5 for fracking a formation 7. Greenhouse gas fluid for sequestration can be transported to the wellsite 153 by a transporter 55 obtained from another source. The sources of the gas can include the sources referenced in FIG. 3A, including a capture drilling rig system 10′ such as shown in FIG. 4A, and fracking wellsite with a capture system 150 such as shown in FIG. 4B, or other wellsites from which a greenhouse gas is captured, as well as other gas fluid sources 152.

Greenhouse gas fluid storage equipment 50 and greenhouse gas fluid injection equipment 60 that can be as described above, and fluidicly coupled to the fracking system 1 and the associated one or more fracking units 11. A transporter 55 can transport greenhouse gas, advantageously as a gas fluid 121, from another source to the greenhouse gas fluid storage equipment. The greenhouse gas fluid storage equipment 50 can provide a gas, such a gas fluid 121, to the greenhouse gas fluid injection equipment 60. The greenhouse gas fluid injection equipment 60 can create sufficiently high pressure for gas fluid 121 to become a supercritical or liquid gas fluid 130 and with sufficiently high pressure to inject into the fracking fluid 4 to create a gas fracking fluid 140, either in the form of intercalating pills 131 or a continuous flow stream, for injection into the well during at least part of the fracking stage, as described in FIG. 3A. The gas fracking fluid 140 can be continue downhole into the well 5 and then into the formation 7 for fracturing and for sequestration of the gas fluid.

More specifically, greenhouse gas, advantageously in the form of gas fluid 121, can be transported from the sources described to the wellsite 6 via a transporter 55 for temporary storage in the greenhouse gas fluid storage equipment 50. The gas fluid 121 from the transporter is provided for storage to the gas fluid storage containers 51A and 51B by controlling inlet valves 52A and 52B. The flow of the gas fluid from the gas fluid storage containers can be controlled through outlet valves 53A and 53B to a low-pressure transfer pump 57 to transfer the gas fluid 121 to the high-pressure greenhouse gas fluid injection equipment 60.

The high-pressure greenhouse gas fluid injection equipment 60 can pump the incoming gas fluid 121 at the below-zero temperature. The greenhouse gas fluid injection equipment 60 can create sufficiently high pressure for gas fluid 121 to become a supercritical or liquid gas fluid 130 at sufficiently high surface temperatures and with sufficiently high pressure to inject into the fracking fluid 4 to create a gas fracking fluid 140.

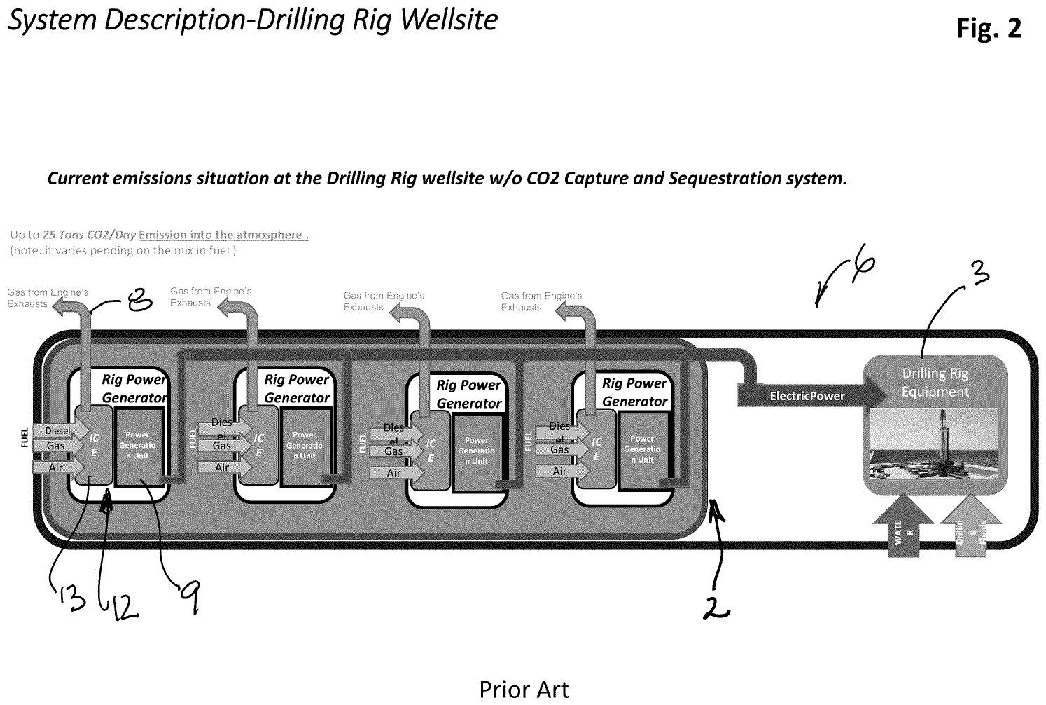

FIG. 4A is a schematic diagram showing an example of an embodiment of an integrated wellsite drilling rig system and method for centralized exhaust gas collection, greenhouse gas capture, and liquification during drilling operations to be transported for injection and downhole sequestration at another location. This embodiment is similar to the schematic diagram in FIG. 2 with the drilling rig power system 2 as an example having one or more power generator units 12 coupled with the drilling rig equipment 3, but is designed to capture greenhouse gas (herein, a “capture drilling rig system” 10′). Also, the capture portion of the system 10′ resembles in part the system described in FIG. 3A, but without the greenhouse gas fluid injection equipment 60 and related fracking equipment.

A capture drilling rig power system 2′ can include one or more power generator units 12, such as described in FIG. 2. The exhaust gases 8 from the ICEs of the power generator units 12 can be combined in an exhaust gas collector 21 of the exhaust gas collection equipment 20 for a combined exhaust gas 100 flow. Additionally, the capture drilling rig power system 2′ can include a waste heat power generation system 22 that can divert exhaust gas 100 into one or more heat exchangers that and power a turbine to produce power for some of the equipment.

The exhaust gas collection equipment 20 can include an exhaust gas blower 23. The exhaust gas blower provides additional energy for the exhaust gas 100 to pass through stages of the system. The exhaust gas can flow to the greenhouse gas capture equipment 30.

The greenhouse gas capture equipment 30 can include a gas cooler 31 to cool the exhaust gas downstream of the exhaust gas blower and fluidicly coupled through a conduit. The greenhouse gas capture equipment can also include an greenhouse gas filter 32 coupled downstream of the exhaust gas cooler for filtering out one or more of the components in the exhaust gas and can released undesirable gas 33 into the atmosphere, while retaining an at least partially purified greenhouse gas 110. Optionally, the purified greenhouse gas 110 can flow to other greenhouse gas capture equipment for like separation of one or more other undesirable gases. A vacuum pump 34 can be coupled downstream of the filter 32 to provide differential pressure to provide additional energy to the gas to pass through stages of the system. Other devices can be used instead of the vacuum pump, depending of the releasing and regeneration methods required by the greenhouse filter. The purified greenhouse gas 110 can flow through a conduit to the greenhouse gas liquification equipment 40.

The greenhouse gas liquification equipment 40 can include a relatively low-pressure gas compressor 41 to form a compressed gas fluid 120 for an initial volume reduction and energy increase, followed by a higher pressure pump 42 to increase pressure of the gas fluid. The gas fluid can be pumped to a greenhouse gas fluid storage equipment 50, which can be at the wellsite in this embodiment.

The greenhouse gas fluid storage equipment 50 preferably stores the gas fluid at a relatively low-pressure and a chilled temperature to help maintain the gas fluid in condensed form. Relief valves 54A and 54B can protect the containers from over-pressurization. The gas fluid can be stored in multiple storage containers 51A and 51B so that one or more containers may be feeding the gas fluid 120 to the gas fluid transporter 55, while one or more other containers are being filled with the gas fluid. Inlet valves 52A and 52B and outlet valves 53A and 53B can direct the incoming and outgoing gas fluid flow. The gas fluid 120 from the storage containers 51 can be transported via the transporter 55 to other locations. For example, other locations could include other wellsites and systems, such as a capture and sequestration fracking system 10, such as shown in FIG. 3A; fracking sequestration system 153 without capture facilities, such as shown in FIG. 3B for sequestration of the gas fluid in a well 5 for a formation 7; and other gas use locations 154, such as enhanced oil recovery facilities, commercial underground greenhouse gas storage, and other facilities using greenhouse gas.

FIG. 4B is a schematic diagram showing an example of another embodiment of the integrated wellsite fracking system and method for standalone exhaust gas collection, greenhouse gas capture, and liquification during fracturing operations to be transported for injection and downhole sequestration at another location. This embodiment illustrates an example of the combinations of the prior described embodiments, among others that are contemplated. This embodiment combines aspects of FIG. 3A with corresponding elements as a fracking wellsite with a gas capture portion of the system but omits the gas fluid injection and sequestration portion of the system, as in FIG. 4A, even though this embodiment can be used in conducting a fracking operation. Similar to the embodiment in FIG. 4A, the captured gas fluid can be transported to other locations as described in FIG. 4A.

FIG. 5 is a schematic diagram showing an example of an embodiment of greenhouse gas capture equipment. The greenhouse gas capture equipment 30 can be used in overall systems such as in the embodiments described in FIGS. 3A, 4A and 4B. Similarly, greenhouse gas capture equipment 30′ described in more detail below can be sized for and used with individual greenhouse gas capture fracking units and greenhouse gas capture power generator units. (The following description of the greenhouse gas capture equipment 30 can apply to the greenhouse gas capture equipment 30′.) The greenhouse gas capture equipment 30 can receive gas, such as exhaust gas 100 having a mixtures of gases, and clean the mixture to produce an at least partially purified greenhouse gas 110, and release the undesirable gas 33 into the atmosphere The greenhouse gas capture equipment 30 can include a gas cooler 31 to cool the incoming exhaust gas 100. The greenhouse gas capture equipment can also include an greenhouse gas filter 32 coupled downstream of the exhaust gas cooler for filtering out one or more of the components in the exhaust gas and can release undesirable gas 33 into the atmosphere (which may not be greenhouse gases), while retaining an at least partially purified greenhouse gas 110. A vacuum pump 34 can be coupled downstream of the filter 32 to provide differential pressure to provide additional energy to the gas to pass through stages of the system. Other devices can be used instead of the vacuum pump, depending of the releasing and regeneration methods required by the greenhouse filter. In an exemplary embodiment, the greenhouse gas capture equipment 30 can use a greenhouse filter. The term “filter” is used broadly to include any method of separating the gases. In one embodiment, it can use a physical and/or chemical absorption method. In this method, the greenhouse gas filter can use specialized liquid chemicals, such as amine solvents with any regeneration process for capturing and releasing the desired gas(es). In another embodiment, the greenhouse gas filter equipment can include physical and/or chemical adsorption method. In this method the greenhouse gas filter can use specialized materials such as, metallic organic frameworks (MOFs), melamine porous networks, graphene, zeolites, each of which use specific principles for capture the CO2 and requires specific methods for releasing the CO2 and regenerating the filter for further CO2 captures. In another embodiment, the greenhouse gas filter equipment can include physical separation like in membranes of different types. In another embodiment, the greenhouse gas capture equipment can biological filtering methods. Still further, in other embodiments, the greenhouse gas capture equipment can include temperature, including cryogenic, equipment and related processes for capturing the desired gas(es). Other devices can be part of the greenhouse gas capture equipment, depending of the releasing and regeneration methods required by the greenhouse gas filter equipment. Other embodiments are also possible, including combinations of the above embodiments. Alternatively, the gas capture equipment can flow the purified greenhouse gas 110 to other greenhouse filter equipment for processing out of one or more other undesirable gases 33 for further purification of the purified greenhouse gas 110. The system can be modular and scalable to accommodate different job sizes with different gas emission volumes and gas purity specifications. Any public transportation of the system, such as being mounted on skids or trailers, could comply with governmental standards.

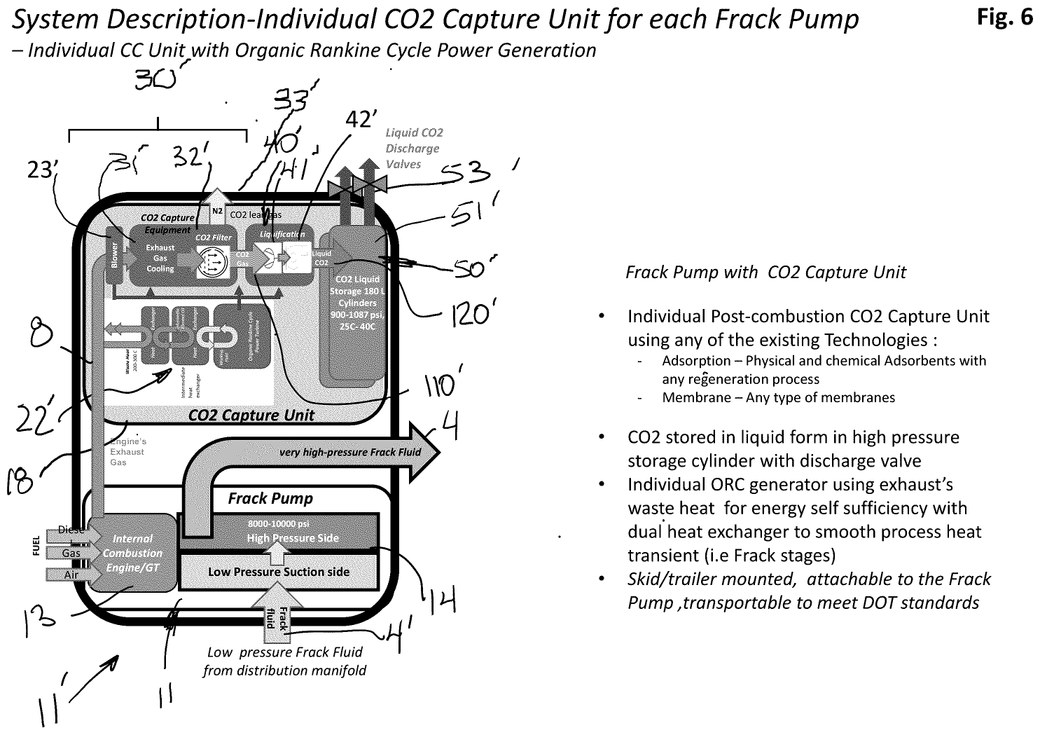

FIG. 6 is a schematic diagram showing an embodiment of an individual fracking unit coupled with a greenhouse gas capture unit. The embodiment includes an individual fracturing unit similar to fracking unit 11, but with an integrated individual greenhouse gas capture unit 18 that collectively forms herein a “greenhouse gas capture fracking unit” 11′. The greenhouse gas capture unit 18 can collect through at least a conduit the exhaust gas from ICE 13 of the fracking unit, capture, liquefy, and intermediately store the greenhouse gas fluid. On a per greenhouse gas capture fracking unit 11′ basis, the exhaust gas does not need to be combined with exhaust gas from other greenhouse gas capture fracking units. The exhaust gas can proceed to an exhaust gas blower 23′ that is used assist flow of the exhaust gas through at least portions of the greenhouse gas capture unit, while avoiding performance-affecting back pressure into the ICE of the fracking unit. The exhaust gas then flows downstream into the greenhouse gas capture equipment 30′ and greenhouse gas liquification equipment 40′, and then into the greenhouse gas fluid storage equipment 50′ with equipment generally described above in the bulk systems having combined exhaust gas flow for multiple fracking units, except that each applicable component can be sized on an individual unit basis.

More specifically, the greenhouse gas capture fracking unit 11′ includes an ICE 13 coupled with a fracking pump 14 for a fracking unit 11. The exhaust gas 8 from the ICE can at least partially flow through a waste heat power generation system 22′ as described above that is appropriately sized for an individual unit to power equipment in the greenhouse gas capture fracking unit 11′ and then return to the main flow of the exhaust gas 8. The exhaust gas can flow through an exhaust gas blower 23′ into the greenhouse gas capture equipment 30′. The greenhouse gas capture equipment 30′ can include an exhaust gas cooler 31′ to cool the exhaust gas. The cooled exhaust gas can flow into a filter 32′ for filtering one or more greenhouse gases in the exhaust gas and releasing undesired gases 33′ into the atmosphere, thereby creating an at least partially purified greenhouse gas 110′ for sequestration. The purified greenhouse gas 110′ can flow to a gas compressor 41′ and a high-pressure pump 42′ to form a gas fluid 120′. The gas fluid can be pumped to at least one and advantageously at least two gas fluid storage containers 51′, such as cylinders. Outlet valves 53′ for the storage cylinders can release the stored gas fluid as needed for further use, such as shown in the system of FIG. 7.

FIG. 7 is a schematic diagram showing a wellsite fracturing system having a plurality of individual greenhouse gas capture fracking units, described in FIG. 6, the system further having greenhouse gas fluid storage equipment and greenhouse gas fluid injection equipment for injecting greenhouse gas fluid into a well formation. In general, this embodiment is termed herein a “unit capture and sequestration fracking system” 151 that includes the individual greenhouse gas capture fracking units 11′ shown in FIG. 6 with common aspects of the overall capture and sequestration fracking system 10 (such as greenhouse gas fluid storage equipment 50 and greenhouse gas fluid injection equipment 60′) shown in FIG. 3A. Fracking fluid 4′ can be prepared with its various components and provided through a fracking fluid inlet low-pressure manifold 29 to a plurality of the greenhouse gas capture fracking units 11′. The individual greenhouse gas capture fracking units can pump the fracking fluid 4′ with the high-pressure fracking pumps described in FIG. 6 to produce high-pressure fracking fluid 4. The output of the high-pressure fracking fluid 4 can flow into an output manifold 17 for injection into the well 5 and therefrom into formation 7.

With the exhaust gas 8 from the ICE passed through the waste heat power generation system, blowed, cooled, filtered, compressed to gas liquid, and stored in the gas storage containers 51′, such as cylinders, in the greenhouse gas capture fracking units 11′, described in FIG. 6, the gas fluid 120′ from each individual greenhouse gas capture fracking unit can flow into a gas fluid transfer manifold 59. The gas fluid transfer manifold 59 can be configured with conduits, piping connected with tees, ells, and other fittings can fluidicly link the gas fluids from the individual storage containers, valving, sensors, controllers and other equipment from the greenhouse gas capture fracking units to the greenhouse gas fluid storage equipment 50. The gas fluid transfer manifold 59 functions as an automatic flow control for unloading the gas liquid from the greenhouse gas capture fracking units 11′ into the greenhouse gas fluid storage equipment 50 using differential pressure as the storage equipment stores gas fluid at a much lower pressure and much lower temperature than the gas fluid transfer manifold to store the gas fluid in liquid form.

The greenhouse gas fluid storage equipment 50 stores the gas fluid at the lower pressure and lower temperature, advantageously in multiple storage containers 51A and 51B to allow incoming gas liquid 120 in one or more containers and outgoing gas fluid from one or more other containers to establish a more constant output flow for further processing. Inlet valves 52A and 52B can direct which container receives incoming gas fluid. Outlet valves 53A and 53B can direct which container feeds the stored gas fluid into downstream equipment. Relief valves 54A and 54B can protect the containers from over-pressurization, such as might be caused through a loss of the cooling capacity on the storage containers. From a flow of gas fluid 120 from the gas storage containers 51, a low-pressure transfer pump 57 in the general range of 100-150 psi can transfer the gas fluid to high-pressure greenhouse gas fluid injection equipment 60′.

The high-pressure greenhouse gas fluid injection equipment 60′ can be form of one or more greenhouse gas capture fracking unit 11′ with an ICE and pump as described in FIG. 6, with the pumps being configured to pump the cold gas fluid 120′ at a sufficiently high pressure to become a supercritical or liquid gas fluid at sufficiently high surface temperatures and with sufficiently high pressure to inject in the form of intercalating pills 131 into the fracking fluid 4 stream in the output manifold 17, or alternatively to be injected in a continuous stream into the manifold 17, to form a gas fracking fluid 140. The gas fracking fluid 140 can be continue downhole into the well 5 and then into the formation 7 for fracturing and for sequestration of the gas fluid.

FIG. 7A is a schematic diagram of an example of a timed sequence for greenhouse gas liquification and storage containers loading and unloading during fracking operations to manage large greenhouse volumes, such as shown in FIG. 7. FIG. 7A is similar to FIG. 3A2 but further includes the sequencing of the greenhouse gas fluid storage equipment 50′, such as the unit storage containers 51′, which can be cylinders, of the gas capture fracking unit 11′ described in FIG. 6. In FIG. 7A, seven graphs are shown in relation to each other for the sequences. Graph 190 represents fracking stages during a fracking operations of gas capture fracking units 11′ with their respective ICEs, such as illustrated in FIG. 7. Graph 200 for a Container 1 represents a sequence of operations of at one least one system storage container for the greenhouse gas fluid, such as storage container 51A. Graph 210 for a Container 2 represents a sequence of operations of at one least one other system storage container for the greenhouse gas fluid, such as storage container 51B. Graph 220 for a Container 1′ represents a sequence of operations of at least one unit storage container 51′ of a given gas capture fracking unit 11′. Graph 230 for a Container 2′ represents a sequence of operations of at least one other unit storage container 51′ of the given gas capture fracking unit 11′. Container 1′ and Container 2′ can be loaded and unloaded reciprocally with gas fluid from an ICE of a particular gas capture fracking unit 11′ to reciprocally flow into the system storage containers 51 in a similar manner as Container 1 and Container 2 can be loaded and unloaded, as described in FIG. 3A2, to flow the gas fluid into gas fluid injection equipment, but generally at a higher frequency than Container 1 and Container 2.

During a first fracking stage 191, sequence 201 for Container 1, and sequence 211 for Container 2: Gas capture fracking units 11′ are operating and producing exhaust gas that can be processed into gas fluid, as described herein, for storage into Container 1′ and Container 2′ and transfer into the system. Container 1′ and Container 2′ can reciprocally load Container 1, while Container 2 can remain unloaded during sequence 201. Container 1′ can be loaded with gas fluid in sequence 221, while Container 2′ remains unloaded at a startup of sequence 201. Container 1′ can be unloaded into Container 1 during sequence 222, while Container 2′ can be loaded with gas fluid in sequence 231. Container 2′ can then be unloaded into Container 1 in sequence 232, while Container 1′ is loaded in sequence 223, and so forth during the loading of Container 1 in sequence 201.

During idle stage 192, sequence 202, and sequence 212, fracking has temporarily paused and the gas capture fracking unit 11's are idling. Container 1′ and Container 2′ have been unloaded into Container 1, which is still loaded, and Container 2 is still not loaded.

Thus, in this embodiment, Container 1 has a storage capacity of at least the volume of greenhouse gas fluid produced during fracking stage 191, and Container 2 can have a similar storage capacity for fracking stages in which it is loaded. However, in other embodiments, Container 2 could be reciprocally loaded and unloaded during the fracking stage 191 in coordination with the unloading and loading of Container 1 and therefore share the fracking stage volume with Container 1 to reduce the size of Container 1 and Container 2. Thus, Container 1 and Container 2 could operate as described for Container 1′ and Container 2′ during fracking stage 191, but with larger volumes. Container 1′ and Container 2′ would reciprocally load during the respective loading periods of each of Containers 1 and 2 during the particular fracking stage.

During a second fracking stage 193, sequence 203, and sequence 213, Container 1 can be unloaded and Container 2 loaded. The unloading can occur by flowing to the gas fluid injection equipment and then into the well and formation for sequestration, as described above. Alternatively, the unloading can occur by transferring to a transporter for injection at another wellsite or other purposes. The unloading can occur faster than the loading, such as illustrated by comparison of sequence 203 and sequence 213. When Container 1 is unloading, Container 2 can be loaded with gas fluid in the same manner as Container 1′ and Container 2′ loaded Container 1. Container 1′ and Container 2′ can reciprocally load Container 2. Container 1′ can be loaded with gas fluid in sequence 224, while Container 2′ can remain unloaded at a startup of sequence 213. Container 1′ can be unloaded into Container 2 during sequence 225, while Container 2′ can be loaded with gas fluid in sequence 234. Container 2′ can then be unloaded into Container 2 in sequence 235, while Container 1′ is loaded in sequence 226, and so forth during the loading of Container 2 in sequence 213.

During idle stage 194, sequence 204, and sequence 214, fracking has temporarily paused and the gas capture fracking unit 11's are idling. Container 1′ and Container 2′ have been unloaded into Container 2, which is still loaded, and Container 1 has been unloaded.

During a third fracking stage 195, sequence 205, and sequence 215, Container 2 can be unloaded and Container 1 loaded again. When Container 2 is unloading, Container 1 can be loaded with gas fluid in the same manner as Container 1 was loaded in the first fracking stage 191. Container 1′ and Container 2′ can reciprocally load Container 1, while Container 2 can be unloaded. Container 1′ can be loaded with gas fluid in sequence 227, while Container 2′ remains unloaded at a startup of sequence 205. Container 1′ can be unloaded into Container 1 during sequence 228, while Container 2′ can be loaded with gas fluid in sequence 236. Container 2′ can then be unloaded into Container 1 in sequence 237, while Container 1′ is loaded in sequence 229, and so forth during the loading of Container 1 in sequence 205.

The processes can be repeated for the remaining frack stages and idle stages for the course of the fracking operation.

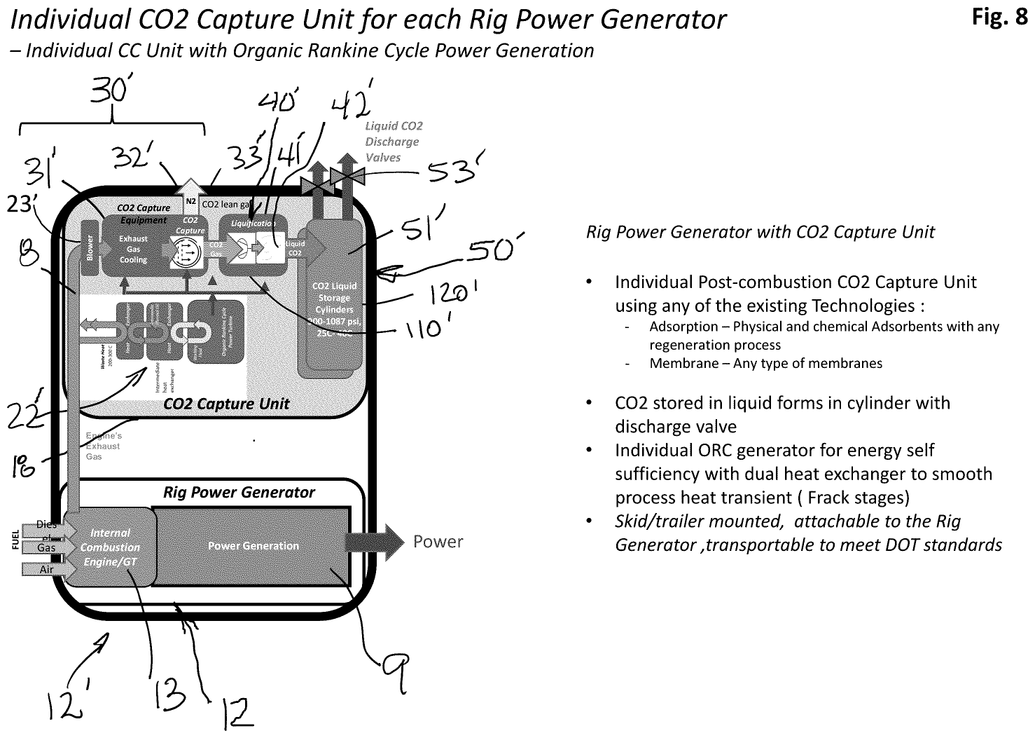

As explained in FIG. 3A2, the above example can be readily applied to the ICEs of the greenhouse gas capture power generator unit 12′ described in FIG. 8 with at least one Container 1′ and Container 2′ reciprocally loaded and unloaded for the Container 1 and Container 2 of the system.

FIG. 8 is a schematic diagram showing an embodiment of an individual power generator unit coupled with a greenhouse gas capture unit used to power at least partially a drilling rig. The embodiment includes an individual power generator unit similar to power generator unit 12, described in at least FIGS. 2 and 4A, but with an integrated individual greenhouse gas capture unit 18 that collectively forms herein a “greenhouse gas capture power generator unit” 12′. The greenhouse gas capture unit 18 can collect through at least a conduit the exhaust gas from ICE 13 of the power generator unit, capture, liquefy, and intermediately store the greenhouse gas fluid. On per greenhouse gas capture power generator unit 12′ basis, the exhaust gas does not need to be combined with exhaust gas from other greenhouse gas capture power generator units and can proceed to greenhouse gas capture equipment 30′, greenhouse gas liquification equipment 40′, and greenhouse gas fluid storage equipment 50′, described above, where each can be sized on an individual unit basis. Depending on the system, an exhaust gas blower (not shown), such as the exhaust gas blower 23 shown in FIG. 3A, may be useful to flow the exhaust gas through at least portions of the greenhouse gas capture unit.

FIG. 8 is a schematic diagram showing an embodiment of an individual power generator unit coupled with a greenhouse gas capture unit used to power at least partially a drilling rig. The embodiment includes an individual power generator unit similar to power generator unit 12, described in at least FIGS. 2 and 4A, but with an integrated individual greenhouse gas capture unit 18 that collectively forms herein a “greenhouse gas capture power generator unit” 12′. The greenhouse gas capture unit 18 can condition the exhaust gas 8 from the ICE 13 of the fracking unit, capture, liquefy, and intermediately store the greenhouse gas fluid. On a per greenhouse gas capture power generator unit 12′ basis, the exhaust gas does not need to be combined with exhaust gas from other greenhouse gas capture power generator units. The exhaust gas can proceed to an exhaust gas blower 23′ that is used assist flow of the exhaust gas through at least portions of the greenhouse gas capture unit, while avoiding performance-affecting back pressure into the ICE of the power generator unit, and then flows downstream into the greenhouse gas capture equipment 30′ and greenhouse gas liquification equipment 40′, and then into the greenhouse gas fluid storage equipment 50′, as described in FIG. 6.

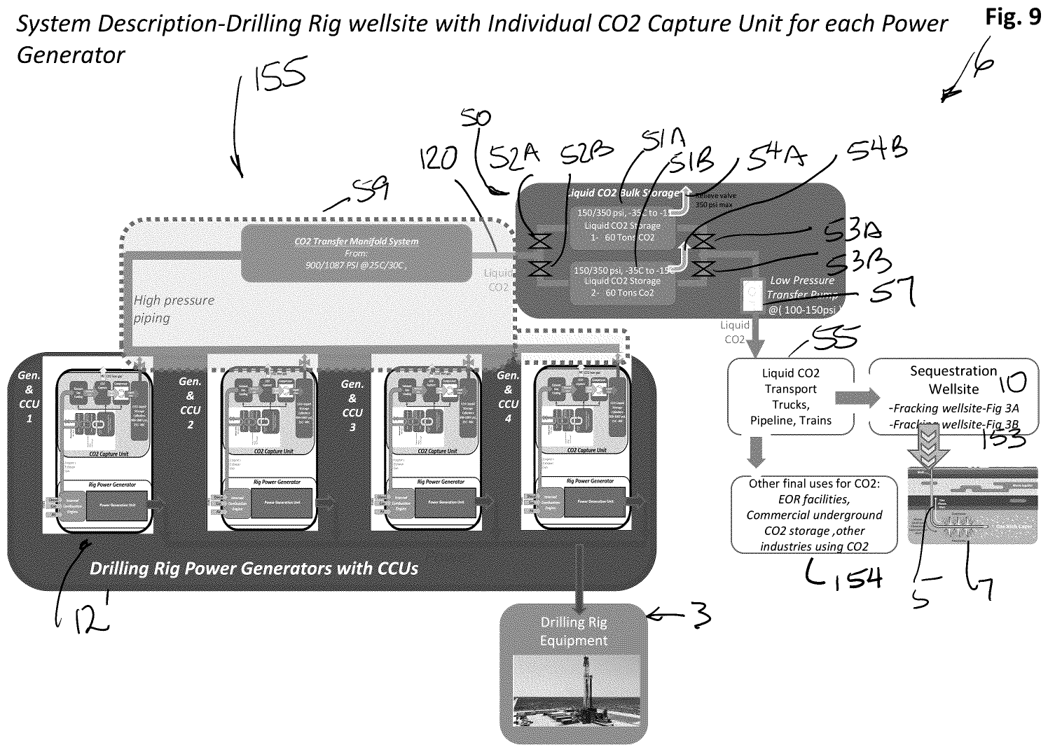

More specifically, the greenhouse gas capture power generator unit 12′ includes an ICE 13 coupled with a power generator 9. The exhaust gas 8 from the ICE can at least partially flow through a waste heat power generation system 22′ as described above that is appropriately sized for an individual unit to power equipment in the greenhouse gas capture power generator unit 12′ and then return to the main flow of the exhaust gas 8. The exhaust gas can flow through an exhaust gas blower 23′ into the greenhouse gas capture equipment 30′. The greenhouse gas capture equipment 30′ can include an exhaust gas cooler 31′ to cool the exhaust gas. The cooled exhaust gas can flow into a filter 32′ for filtering one or more greenhouse gases in the exhaust gas and releasing undesired gases 33′ into the atmosphere, thereby creating an at least partially purified greenhouse gas 110′ for sequestration. The purified greenhouse gas 110′ can flow to a gas compressor 41′ and a high-pressure pump 42′ to form a gas fluid 120′. The gas fluid can be pumped to at least one and advantageously at least two gas fluid storage containers 51′, such as cylinders. Outlet valves 53′ for the storage cylinders can release the stored gas fluid as needed for further use, such as shown in the system of FIG. 9.

FIG. 9 is a schematic diagram showing a drilling rig system having a plurality of individual power generator units coupled with greenhouse gas capture units to collect and store for transportation to another location. In general, this embodiment is termed a “unit capture drilling rig system” 155 and includes the greenhouse gas capture power generator units 12′ shown in FIG. 8 with common aspects of the overall system 10′, shown in FIG. 4A for merging the individual greenhouse gas fluids into greenhouse gas fluid storage equipment 50 for transportation of the captured greenhouse gas to another location.

With the exhaust gas 8 from the ICE passed through the waste heat power generation system, cooled, filtered, and compressed to gas liquid in the greenhouse gas capture power generator units 12′, described in FIG. 8, the gas fluid 120 from each individual greenhouse gas capture power generator unit can flow into a gas fluid transfer manifold 59. The gas fluid transfer manifold 59 can be configured with conduits, piping connected with tees, ells, and other fittings can fluidicly link the gas fluids from the individual storage cylinders, valving, sensors, controllers and other equipment from the greenhouse gas capture power generator units to the greenhouse gas fluid storage equipment 50. The gas fluid transfer manifold 59 functions as an automatic flow control for off-loading the gas liquid from the greenhouse gas capture power generator units into the greenhouse gas fluid storage equipment 50 using the differential pressure as it stores gas fluid at a much lower pressure and much lower temperature preserving the liquid gas fluid form.

The greenhouse gas fluid storage equipment 50 stores the gas fluid at the lower pressure and lower temperature, advantageously in multiple storage containers 51A and 51B to allow incoming gas liquid 120 in one or more containers and outgoing gas fluid from one or more other containers to establish a more constant output flow for further processing. Inlet valves 52A and 52B can direct which container receives incoming gas fluid. Outlet valves 53A and 53B can direct which container feeds the stored gas fluid into downstream equipment. Relief valves 54A and 54B can protect the containers from over-pressurization, such as might be caused through a loss of the cooling capacity on the storage containers.

A transfer pump 57 can pump the gas fluid 120 from the containers 51 to a transporter 55. The transporter 55 can transport the gas fluid 120 in various ways to one or more other locations generally for sequestration. For example, other locations could include other wellsites and systems, such as a capture and sequestration fracking system 10, such as shown in FIG. 4B; fracking sequestration system 153 without capture facilities, such as shown in FIG. 3B for sequestration of the gas fluid in a well 5 for a formation 7; and other gas use locations 154, such as enhanced oil recovery facilities, commercial underground greenhouse gas storage, and other facilities using greenhouse gas.

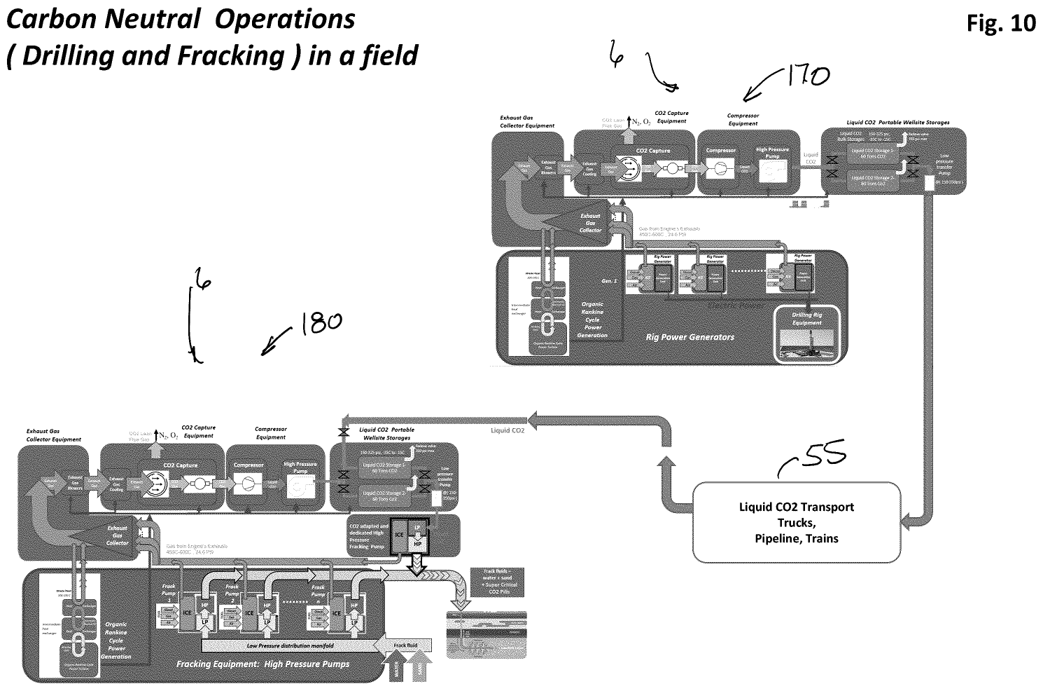

FIG. 10 is a schematic diagram showing an example of an embodiment with a first wellsite as a greenhouse gas capture wellsite while drilling and a second wellsite as a greenhouse gas sequestration wellsite while fracturing for a combined capture and sequestration system having a carbon neutral operation. In this schematic diagram, a first wellsite in the upper right of the diagram can be a “greenhouse gas capture wellsite” 170, such as having a capture drilling rig system 10′ or unit capture drilling rig system 155, such as exemplified in FIGS. 4A and 9, respectively. As variations, the greenhouse gas capture wellsite 170 can have a capture system 150 embodiment in FIG. 4B, or a capture and sequestration fracking system 10 embodiment in FIG. 3A (which can function as a capture wellsite), and other variations not shown can be used as a capture wellsite. The greenhouse gas capture wellsite 170 can collect and otherwise process the gas and advantageously result in a gas fluid for efficiency of transportation to the second wellsite.

A second wellsite in the lower left of the diagram, as a “greenhouse gas sequestration wellsite” 180, can sequester the gas from the greenhouse gas capture wellsite 170, and in some embodiments, its own gas, as exemplified in a capture and sequestration fracking system 10, shown in FIGS. 3A and 7. As variations, the greenhouse gas sequestration wellsite 180 can have a fracking sequestration system 153, shown in FIG. 3B. The gas fluid can be transported to the greenhouse gas sequestration wellsite for injection and sequestration. The wellsites can be in the same field and therefore “in-situ” as defined herein, or can be at other locations outside of the field. The overall system results in a reduced carbon footprint due to the combined capture and sequestration portions. The reduction occurs for a wellsite with both capabilities such as in FIGS. 3A and 7, or for two or more wellsites in combination with each other as a system, as described herein.

Other and further embodiments utilizing one or more aspects of the inventions described above can be devised without departing from the disclosed invention as defined in the claims. For example, the terms “wellsite” and “well” are intended to be construed broadly herein to include other types of wellsites and wells, such as unconventional fracking, conventional wellsites, production wells, reinjection wells, water wells, boreholes, and other holes in the Earth's surface, including subsea locations that may use offshore drilling rigs and offshore production platforms. In particular, offshore drilling rigs and offshore production platforms operations also require power generation at the wellsite and thus also produce greenhouse gases, such as carbon dioxide, and may benefit from capturing and sequestration systems utilizing one or more aspects described herein. As another example, other embodiments can include various other gases, other types of greenhouse gas capture equipment, other types of injection equipment, and other variations than those specifically disclosed herein within the scope of the claims. Further, the various embodiments can be combined or split in various ways, such as different portions of the overall system equipment being located at different wellsites or other locations.

The invention has been described in the context of preferred and other embodiments and not every embodiment of the invention has been described. Obvious modifications and alterations to the described embodiments are available to those of ordinary skill in the art. The disclosed and undisclosed embodiments are not intended to limit or restrict the scope or applicability of the invention conceived of by the Applicants, but rather, in conformity with the patent laws, Applicants intend to protect fully all such modifications and improvements that come within the scope of the following claims.

What is claimed is:

1. An integrated system for capture and sequestration of greenhouse gas, the system configured to interface with wellsite exhaust gas generation equipment that generates exhaust gas having at least one greenhouse gas and fracking equipment that injects a flow stream of high-pressure fracking fluid into a downhole geological formation, comprising:
exhaust gas collection equipment configured to collect the exhaust gas from the gas generation equipment;
greenhouse gas capture equipment configured to receive a flow of the exhaust gas from the exhaust gas collection equipment and separate the greenhouse gas to be captured from the exhaust gas;
greenhouse gas liquification equipment configured to receive a flow of the greenhouse gas from the greenhouse gas capture equipment and reduce the greenhouse gas to a greenhouse gas fluid;
greenhouse gas fluid storage equipment configured to receive a flow of the greenhouse gas fluid from the greenhouse gas liquification equipment and at least temporarily store the greenhouse gas fluid; and
greenhouse gas fluid injection equipment configured to receive a flow of the greenhouse gas fluid from the greenhouse gas fluid storage equipment and inject the greenhouse gas fluid into the geological formation for sequestration.

2. The system of claim 1, wherein the system is coupled to a wellsite and configured to capture the greenhouse gas and in-situ flow the greenhouse gas fluid into the formation.

3. The system of claim 2, wherein the system is configured to receive the greenhouse gas fluid from another location to flow into the geological formation.

4. The system of claim 1, wherein
a first portion of the system at a first wellsite comprises the exhaust gas collection equipment, the greenhouse gas capture equipment, the greenhouse gas liquification equipment, and the greenhouse gas fluid storage equipment; and
a second portion of the system at a second wellsite having the geological formation for sequestration comprises the greenhouse gas fluid injection equipment configured to receive the greenhouse gas fluid from the greenhouse gas fluid storage equipment at the first wellsite and inject the greenhouse gas fluid into the geological formation.

5. The system of claim 4, wherein the first wellsite comprises at least one of a drilling rig wellsite and a fracking wellsite and the second wellsite comprises a fracking wellsite.

6. The system of claim 1, wherein the system is configured to receive additional gas fluid from another location to inject into the geological formation.

7. The system of claim 1, wherein the greenhouse gas fluid injection equipment is configured to inject the greenhouse gas fluid in a supercritical or liquid form.

8. The system of claim 1, wherein the greenhouse gas fluid injection equipment is configured to inject the greenhouse gas fluid into the geological formation that is followed by at least a portion of the fracking fluid stream from the fracking equipment into the geological formation.

9. The system of claim 1, wherein the greenhouse gas fluid injection equipment is configured to intercalate discrete portions of the greenhouse gas fluid into the fracking fluid from the fracking equipment for injection of the discrete portions with the fracking fluid into the geological formation.

10. The system of claim 1, wherein a greenhouse gas capture wellsite comprises at least the greenhouse gas capture equipment and a greenhouse gas sequestration wellsite comprises at least the greenhouse gas fluid injection equipment, and wherein the greenhouse gas sequestration wellsite is configured to receive greenhouse gas fluid from the greenhouse gas capture wellsite for injection into the greenhouse gas sequestration wellsite.

11. The system of claim 1, wherein the greenhouse gas fluid storage equipment comprises at least at first storage container and a second storage container, wherein the first storage container is configured to be loaded with a portion of the greenhouse gas fluid when the second storage container is configured for a time to be unloading a different portion of the greenhouse gas fluid, and the second container is configured to be loaded with another portion of the greenhouse gas fluid when the first storage container is configured to be unloading for a time another different portion of the greenhouse gas fluid.

11.1. The system of claim 1, wherein at least a portion of the exhaust gas collection equipment, greenhouse gas capture equipment, greenhouse gas liquification equipment, and greenhouse gas fluid storage equipment is sized for individual wellsite exhaust gas generation equipment at a wellsite.

11.2. The system of claim 1, wherein at least a portion of the exhaust gas collection equipment, greenhouse gas capture equipment, greenhouse gas liquification equipment, and greenhouse gas fluid storage equipment is sized for a plurality of wellsite exhaust gas generation equipment at a wellsite.

12. A system for capturing greenhouse gas at a wellsite, the system configured to interface with wellsite exhaust gas generation equipment that generates exhaust gas having at least one greenhouse gas, comprising:
greenhouse gas capture equipment configured to receive a flow of the exhaust gas and separate the greenhouse gas from the exhaust gas;
greenhouse gas liquification equipment configured to receive a flow of the greenhouse gas from the greenhouse gas capture equipment and reduce the greenhouse gas to a greenhouse gas fluid, and
greenhouse gas fluid storage equipment configured to receive a flow of the greenhouse gas fluid from the greenhouse gas liquification equipment and at least temporarily store the greenhouse gas fluid for at least one of injection into a geological formation at the wellsite and transportation to another location.

13. The system of claim 12, wherein the transportation to another location comprises transportation to at least one of another wellsite configured to frack a geological formation, an enhanced oil recovery facility, an underground gas storage facility, and facilities using the gas to be stored.

14. The system of claim 12, wherein the greenhouse gas fluid storage equipment comprises at least at first storage container and a second storage container, wherein the first storage container is configured to be loaded with a portion of the greenhouse gas fluid when the second storage container is configured for a time to be unloading a different portion of the greenhouse gas fluid, and the second container is configured to be loaded with another portion of the greenhouse gas fluid when the first storage container is configured to be unloading for a time another different portion of the greenhouse gas fluid.

15. A system for sequestering greenhouse gas into a wellsite geological formation, the system having fracking equipment that injects high-pressure fracking fluid into the geological formation, comprising:
greenhouse gas fluid injection equipment configured to receive a greenhouse gas fluid captured from exhaust gas and to inject the greenhouse gas fluid into the geological formation for sequestration.

16. The system of claim 15, wherein the greenhouse gas fluid injection equipment is configured to intercalate discrete portions of the greenhouse gas fluid into the fracking fluid for injection of the discrete portions with the fracking fluid into the geological formation.

17. A system of storing a quantity of a gas fluid with storage containers having a total capacity less than the quantity of the gas fluid, comprising:
a first storage container configured to load a portion of the quantity of gas fluid and thereafter unload the portion for processing or transportation;
a second storage container configured to load a next portion of the quantity of gas fluid when the first storage container is configured to unload the portion and thereafter unload the next portion for processing or transportation;
the first storage container configured to load a further next portion of the quantity of gas fluid when the second storage container is configured to unload the next portion and thereafter unload at least the further next portion for processing or transportation; and
wherein the first storage container is configured to continue to load and unload when the second storage container is configured to unload and load respectively until the quantity of the gas fluid has been loaded and unloaded.

18. An integrated method for capture and sequestration of greenhouse gas from wellsite exhaust gas generation equipment that generates exhaust gas having at least one greenhouse gas and fracking equipment that injects a flow stream of high-pressure fracking fluid into a downhole geological formation, comprising:
collecting with exhaust gas collection equipment the exhaust gas from the gas generation equipment;
receiving with greenhouse gas capture equipment a flow of the exhaust gas from the exhaust gas collection equipment and separating the greenhouse gas to be captured from the exhaust gas;
receiving with greenhouse gas liquification equipment a flow of the greenhouse gas from the greenhouse gas capture equipment and reducing the greenhouse gas to a greenhouse gas fluid;
receiving with greenhouse gas fluid storage equipment a flow of the greenhouse gas fluid from the greenhouse gas liquification equipment and at least temporarily storing the greenhouse gas fluid; and
receiving with greenhouse gas fluid injection equipment a flow of the greenhouse gas fluid from the greenhouse gas fluid storage equipment and injecting the greenhouse gas fluid into the geological formation for sequestration.

19. A method of storing a quantity of a gas fluid with storage containers having a total capacity less than the quantity of the gas fluid, comprising:
loading a portion of the quantity of gas fluid in a first storage container and thereafter unloading the portion for processing or transportation;
load a next portion of the quantity of gas fluid in a second storage container when unloading the portion in the first storage container and thereafter unloading the next portion in the second storage container for processing or transportation;
load a further next portion of the quantity of gas fluid in the first storage container when unloading the next portion in the second storage container and thereafter unloading at least the further next portion in the first storage container for processing or transportation; and
repeating loading and unloading the first storage container when unloading and loading the second storage container respectively until the quantity of the gas fluid has been loaded and unloaded.
